(19) United States
(12) Patent Application Publication
(10) Pub. No.: US 2018/0240241 A1
(43) Pub. Date: Aug. 23, 2018

(54) THREE-DIMENSIONAL IMAGER

(71) Applicant: FARO Technologies, Inc., Lake Mary, FL (US)

(72) Inventors: Matthew Armstrong, Glenmoore, PA (US); Joydeep Yadav, Exton, PA (US)

(21) Appl. No.: 15/817,652

(22) Filed: Nov. 20, 2017

Related U.S. Application Data
(60) Provisional application No. 62/461,924, filed on Feb. 22, 2017.

(51) Int. Cl. G06T 7/13; G06T 7/73; H04N 13/02

(52) U.S. Cl. CPC G06T 7/13; G06T 7/74; H04N 2213/001; G06T 2207/10028; H04N 13/0239

(57) ABSTRACT

A system and method for generating a point cloud of a scanned object is provided. The method includes determining a distance to each of a plurality of points on the object based at least in part on a phase shift of a light emitted from a measurement device having at least two image devices. A point cloud is generated based at least in part on the distances to the plurality of points. An edge point is identified from a 2D image acquired by one of the image devices. A corresponding point is determined in the other image device based at least in part on a first phase value of the edge point and a epipolar relationship between the image devices. The 3D coordinates of the edge point and the corresponding point are determined based on triangulation. The edge point is added to the point cloud.

### CROSS REFERENCE TO RELATED APPLICATIONS

The present application is a Nonprovisional Application of U.S. Provisional Patent Application Ser. No. 62/461,924 filed on Feb. 22, 2017, the contents of which are incorporated herein by reference in their entirety.

### BACKGROUND

The present invention relates generally to a system and method of generating point cloud data of a scanned object, and in particular, to a system and method that improves point cloud data for edge features.

A 3D imager uses a triangulation method to measure the 3D coordinates of points on an object. The 3D imager usually includes a projector that projects onto a surface of the object either a pattern of light in a line or a pattern of light covering an area. A camera is coupled to the projector in a fixed relationship, for example, by attaching a camera and the projector to a common frame. The light emitted from the projector is reflected off the object surface and detected by the camera. Since the camera and projector are arranged in a fixed relationship, the distance to the object may be determined using trigonometric principles. Compared to coordinate measurement devices that use tactile probes, triangulation systems provide advantages in quickly acquiring coordinate data over a large area. As used herein, the resulting collection of 3D coordinate values or data points of the object being measured by the triangulation system is referred to as point cloud data or simply a point cloud.

In some situations the measurement of edge features, such as the edge of a hole for example, are problematic depending on how the pattern of light strikes the surface or the texture of the surface and edge. As a result, some of the data points measured at or near the edge may be discarded resulting in a lower point density and a point cloud that may not accurately represent the edge feature.

Accordingly, while existing triangulation-based 3D imager devices are suitable for their intended purpose, the need for improvement remains, particularly in providing improved edge detection and measurement of edge features.

### BRIEF DESCRIPTION

According to an embodiment of the present invention, a method for generating a point cloud of a scanned object is provided. The method includes determining a distance to each of a plurality of points on the object based at least in part on a phase shift of a light emitted from a coordinate measurement device having at least two image devices, wherein at least one of the image devices includes a first camera having an array of pixels. A point cloud is generated based at least in part on the distances to the plurality of points. An edge point is identified from a two-dimensional image acquired by the first camera. A corresponding point is determined in the other image device based at least in part on a first phase value of the edge point and a epipolar relationship between the first camera and the image device. The three-dimensional coordinates of the edge point and the corresponding point are determined based on triangulation. The edge point is added to the point cloud.

According to an embodiment of the present invention, a system for generating a point cloud of a scanned object is provided. The system includes a coordinate measurement device having at least two image devices. The at least two image devices including a first camera. The coordinate measurement device being operable to determine a distance to each of a plurality of points on the object using a phase based at least in part on a phase shift of a light emitted from a coordinate measurement device. One or more processors are provided that are responsive to executable computer instructions when performed on the one or more processors for performing a method comprising: generating a point cloud based at least in part on the distances to the plurality of points; identifying an edge point from a two-dimensional image acquired by the first camera; determining a corresponding point in the other image device based at least in part on a first phase value of the edge point and a epipolar relationship between the first camera and the image device; determining the three-dimensional coordinates of the edge point and corresponding point based on triangulation; and adding the edge point to the point cloud.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a 3D imager according to an embodiment;

FIG. 2 is a perspective view of internal elements of a 3D imager having its cover removed according to an embodiment;

FIG. 3 is a perspective view of a projector-camera assembly of a 3D imager according to an embodiment;

FIG. 4 is a top view of internal elements of a 3D imager having its cover removed according to an embodiment;

FIG. 5A is a cross sectional view of the projector-camera assembly according to an embodiment;

FIG. 5B is a perspective view of a light pipe according to an embodiment;

FIG. 6A is a partial perspective view of cooling vents surrounding a projector lens assembly according to an embodiment;

FIG. 6B is a partial perspective view of cooling vents surrounding a camera lens assembly according to an embodiment;

FIG. 6C is a partial perspective view of projector source cooling elements according to an embodiment;

FIG. 7 is a block diagram of electrical components of a 3D imager according to an embodiment;

FIG. 8 is a block diagram of a processor system according to an embodiment;

FIG. 9 is a schematic illustration of the principle of operation of a triangulation scanner having a camera and a projector according to an embodiment;

FIG. 10 is a schematic illustration of the principle of operation of a triangulation scanner having two cameras and one projector according to an embodiment;

FIG. 11 is a perspective view of a scanner having two cameras and one projector arranged in a triangle for 3D measurement according to an embodiment;

FIGS. 12A and 12B are schematic illustrations of the principle of operation of the scanner of FIG. 11;

FIGS. 13A and 13B are schematic illustrations of 3D imagers having wide field-of-view (FOV) lenses and narrow FOV lenses, respectively, according to an embodiment;

FIG. 13C is a schematic representation of camera and projector lenses according to an embodiment;

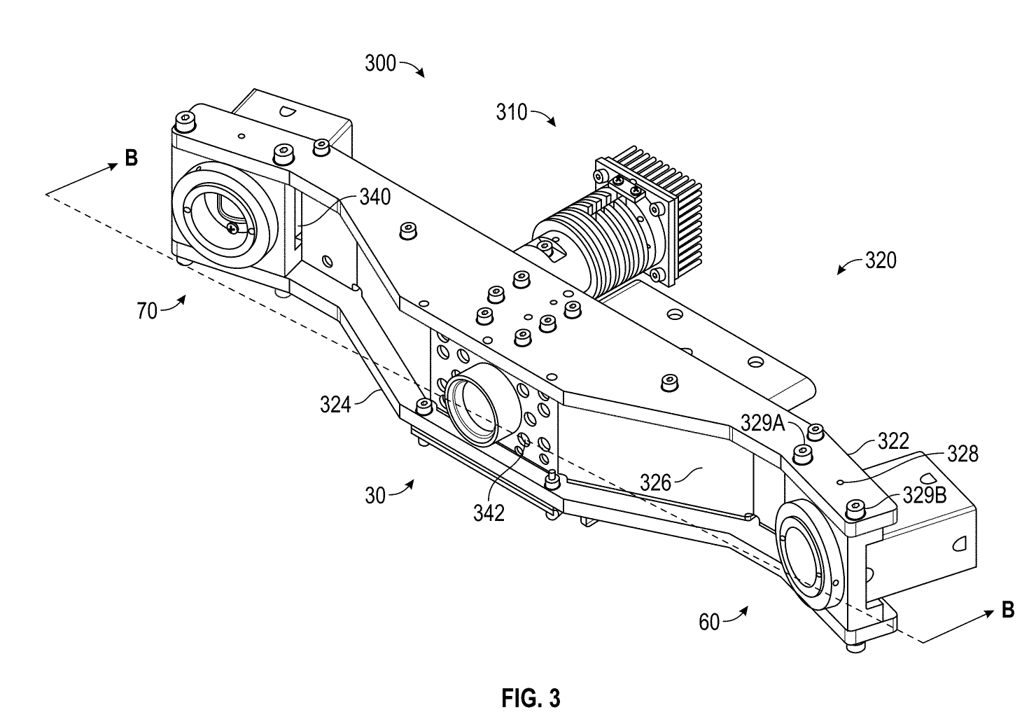

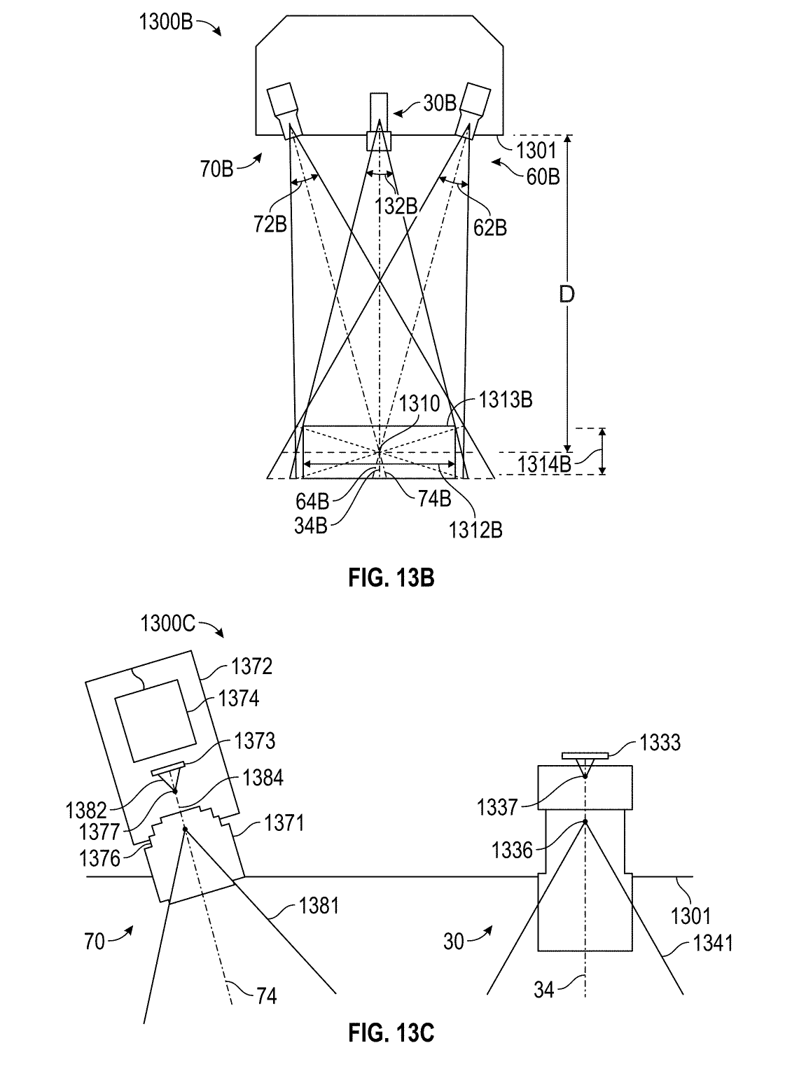

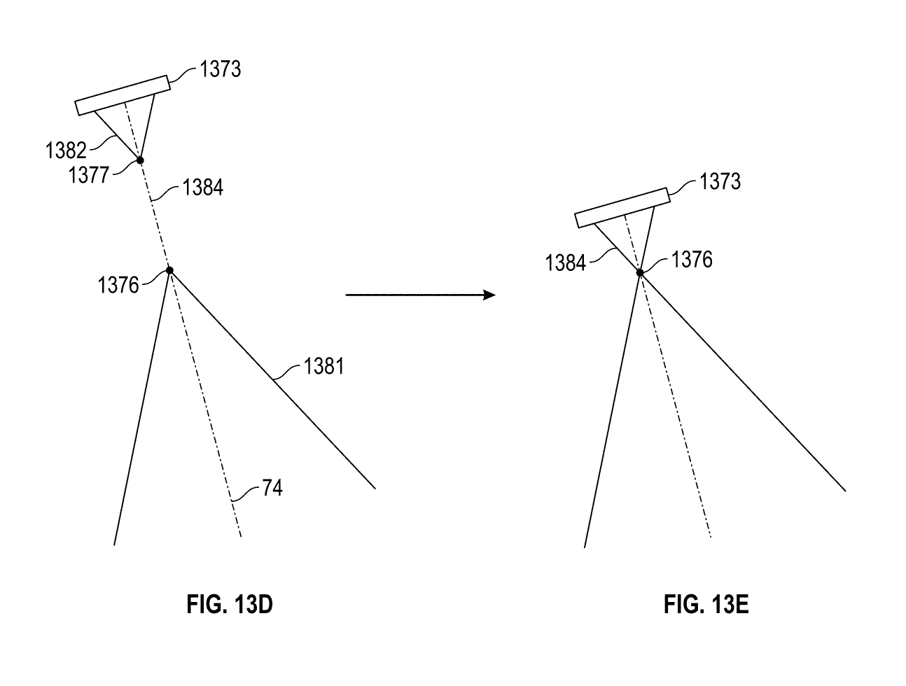

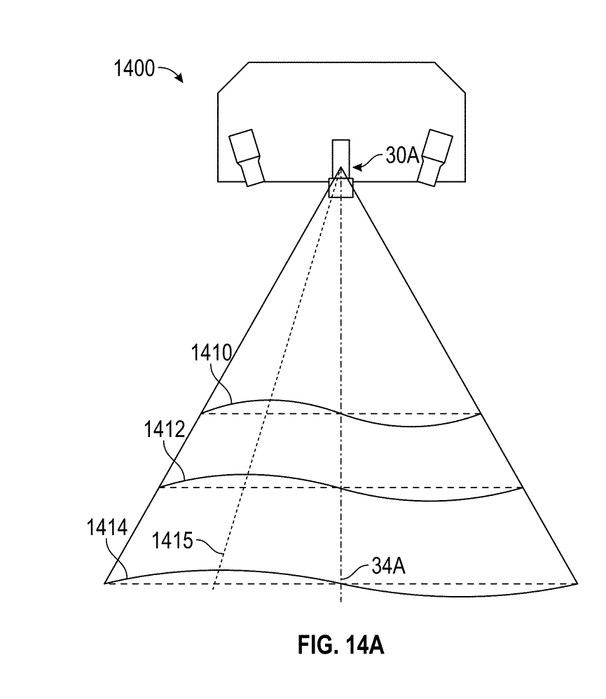

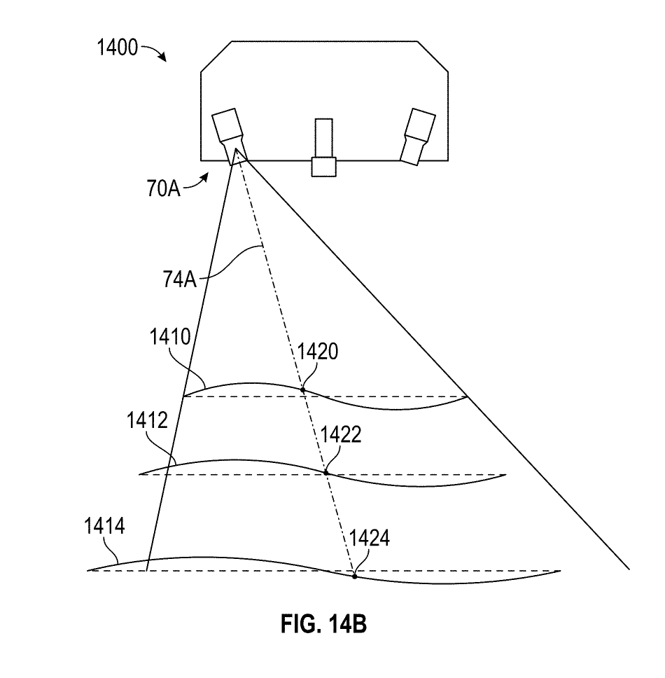

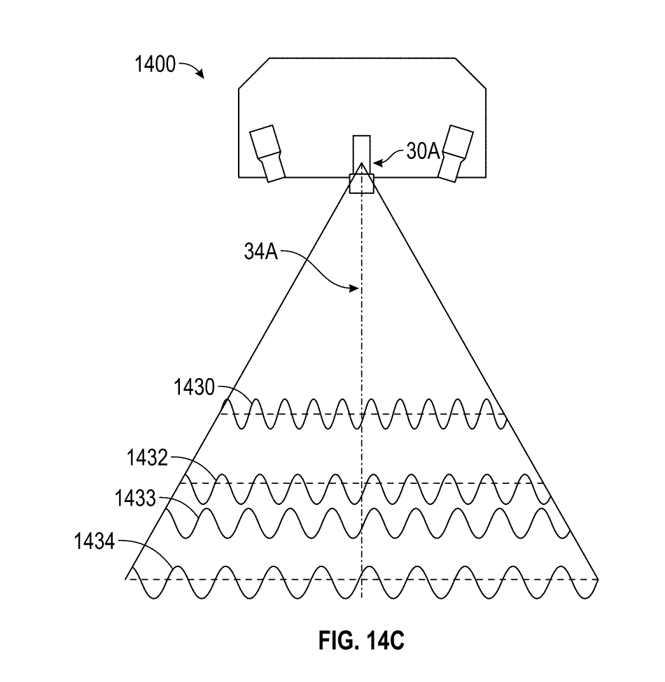

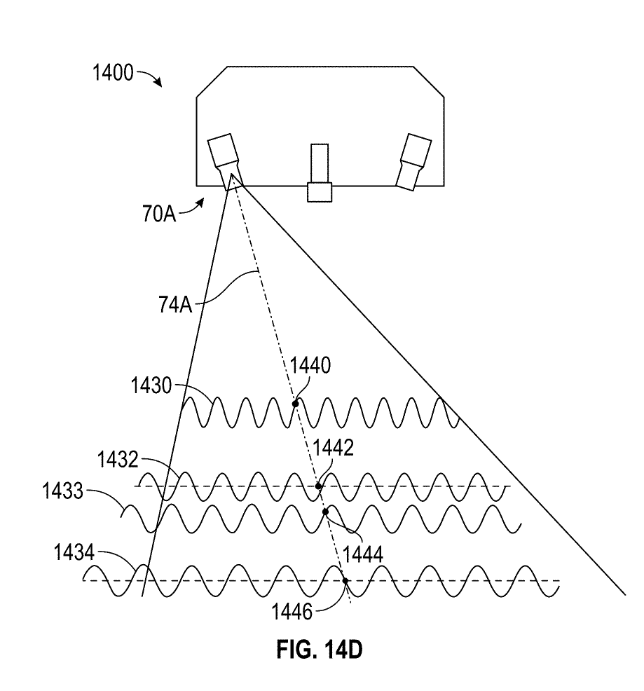

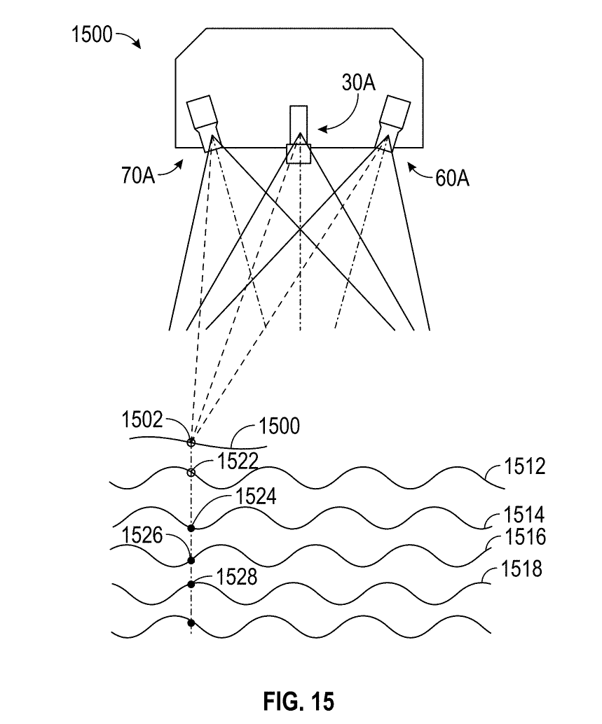

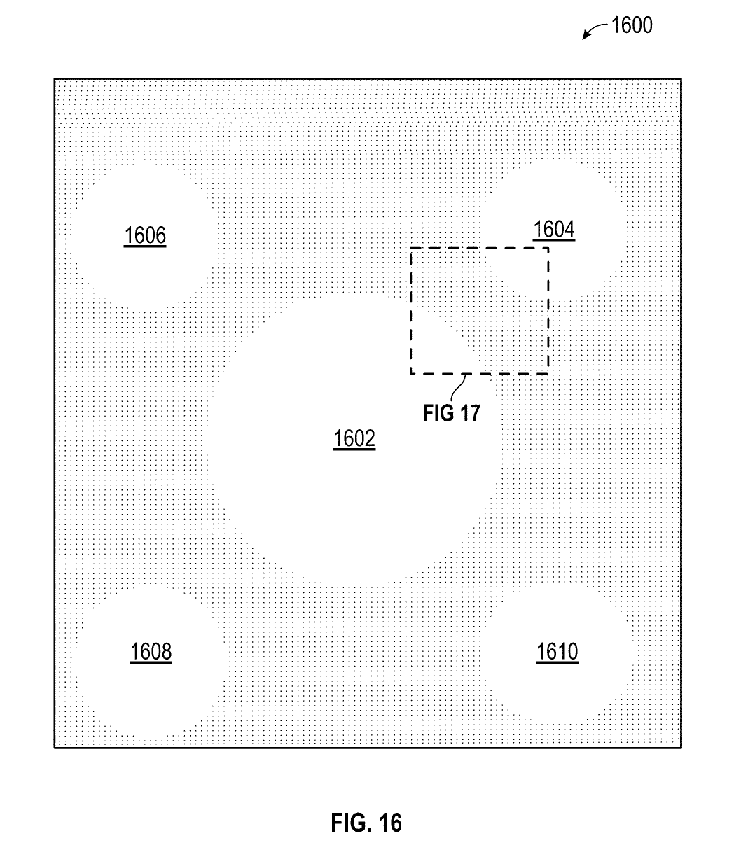

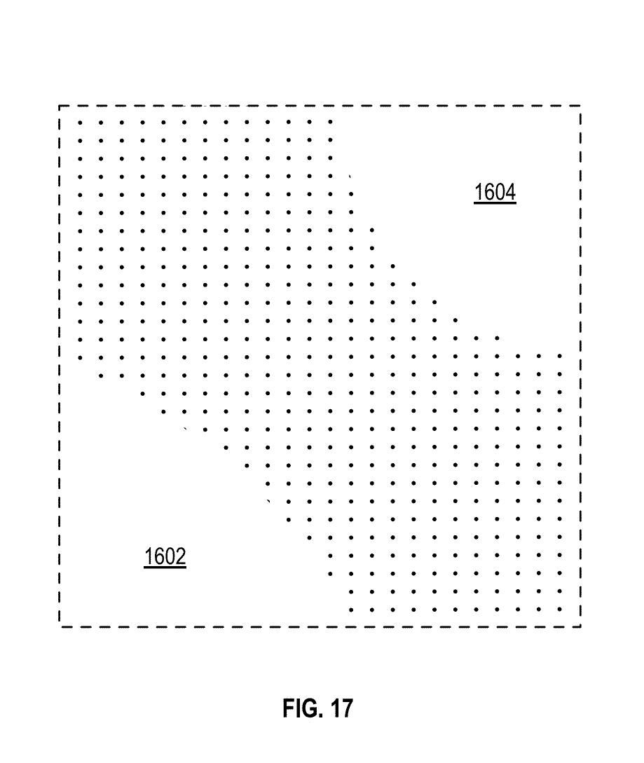

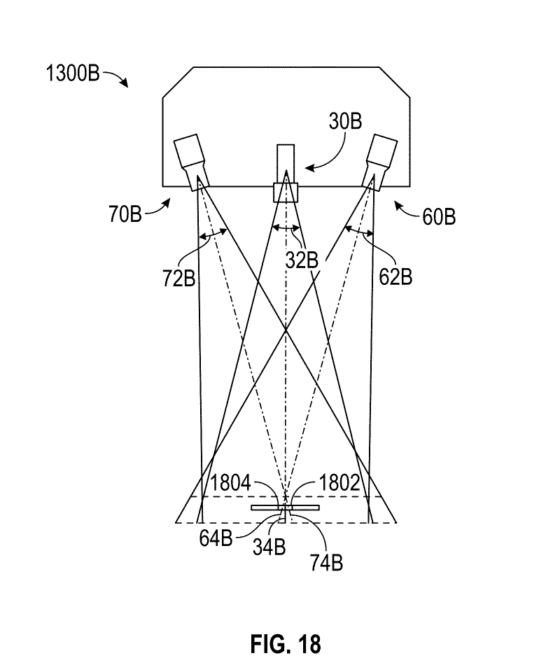

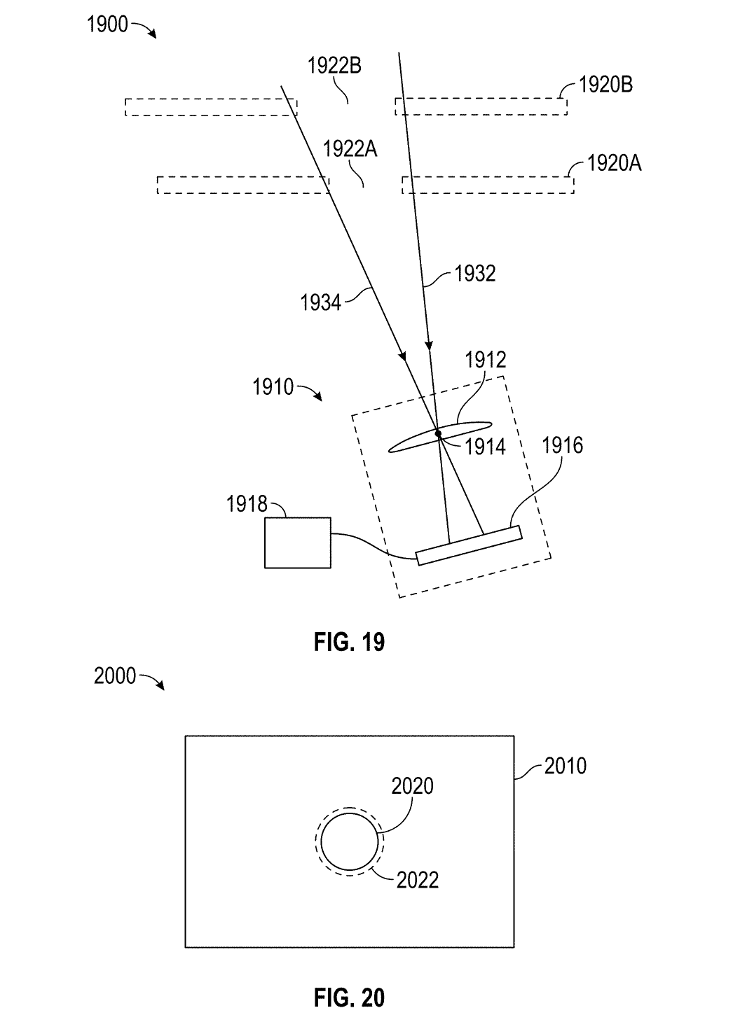

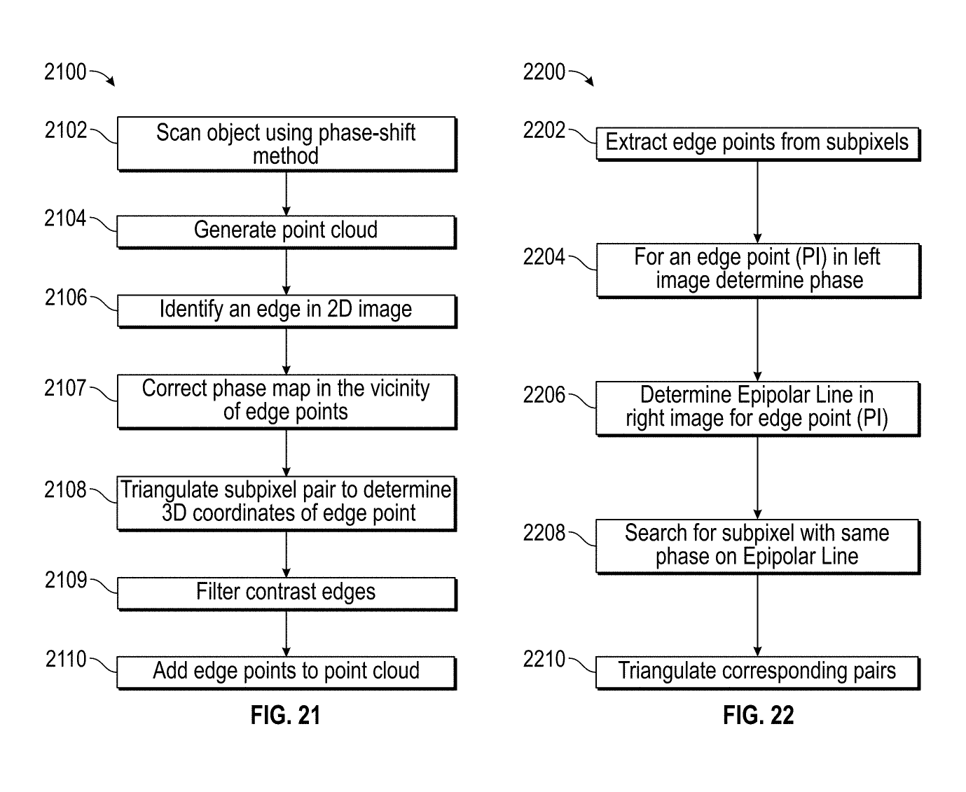

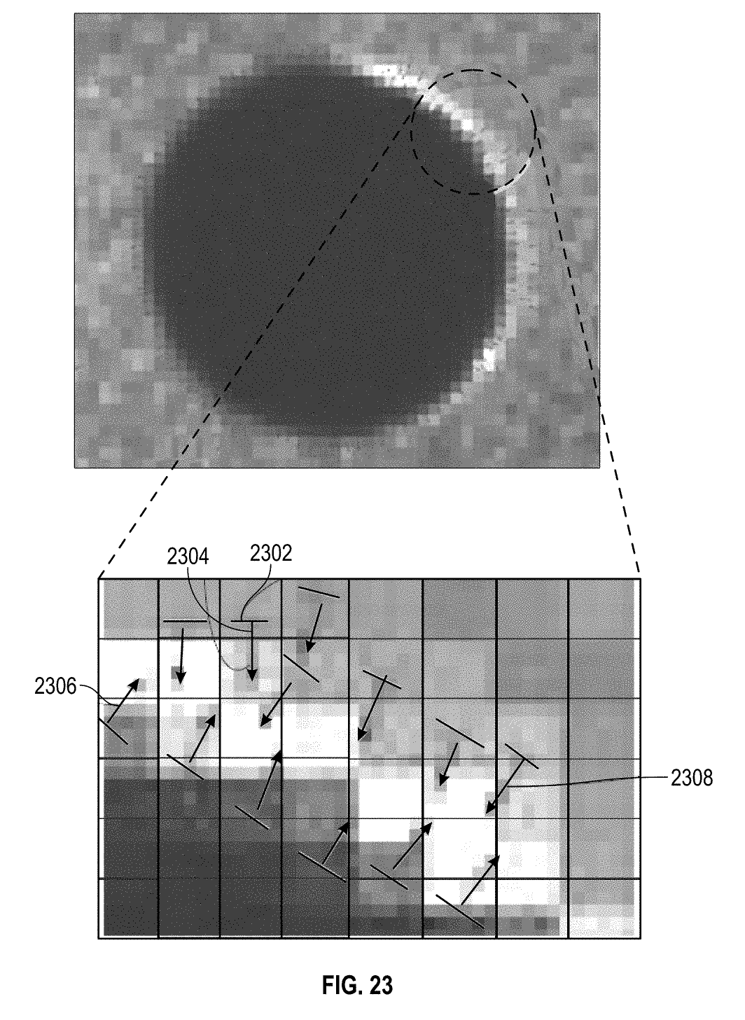

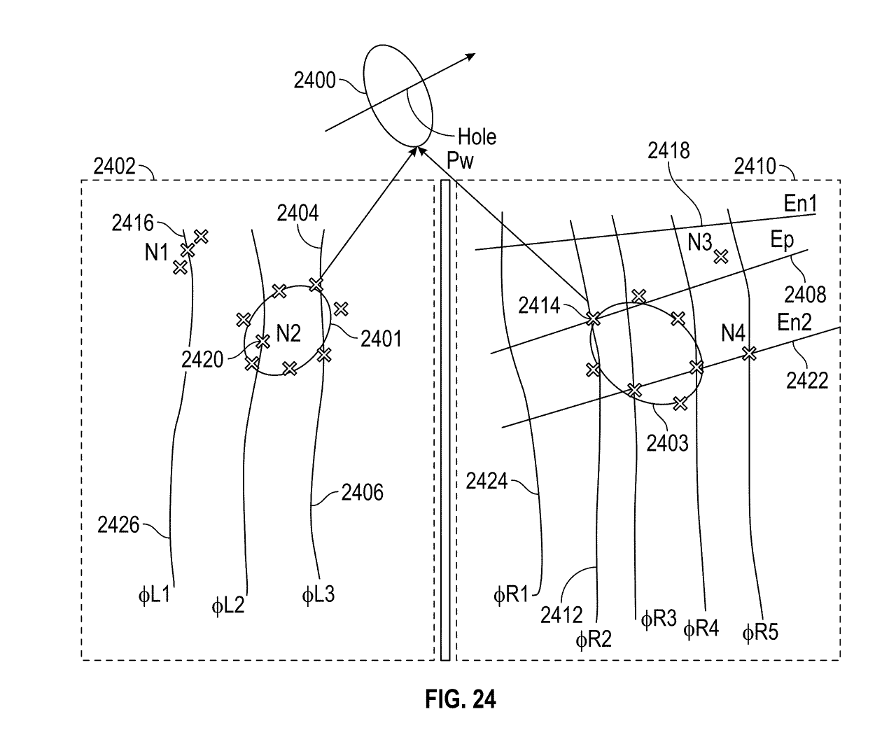

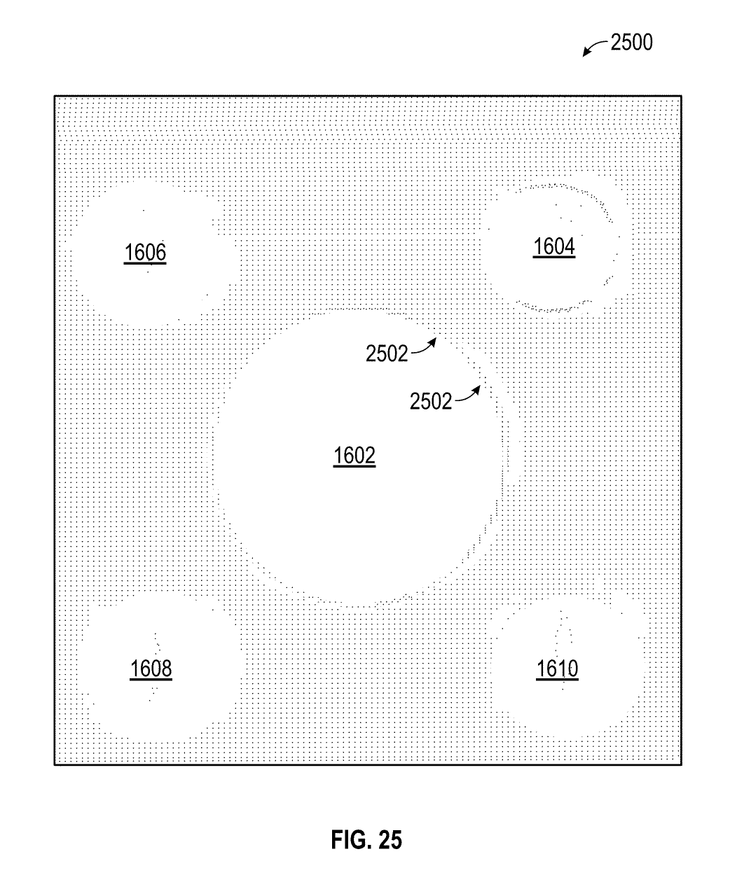

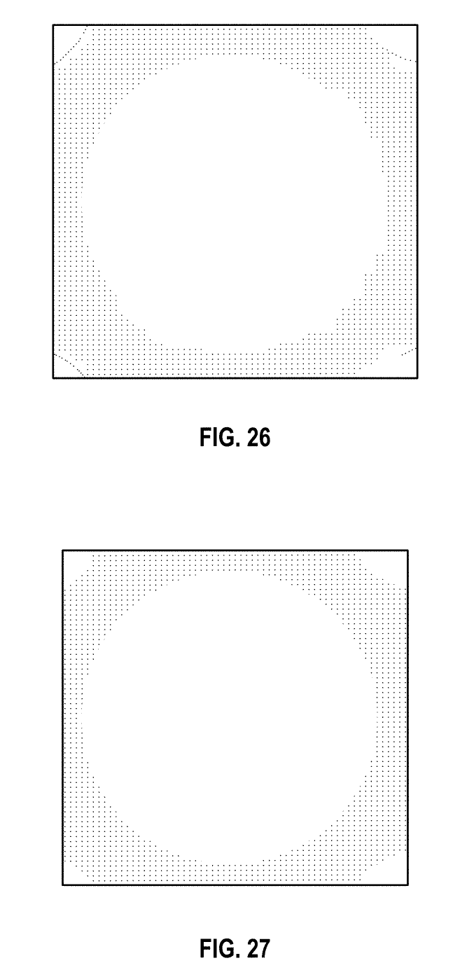

FIGS. 3D and 13E are schematic representations of ray models used for the camera and projector lenses;

FIG. 14A illustrates projection of a coarse sine-wave pattern according to an embodiment;

FIG. 14B illustrates reception of the coarse sine-wave pattern by a camera lens according to an embodiment;

FIG. 14C illustrates projection of a finer sine-wave pattern according to an embodiment;

FIG. 14D illustrates reception of the finer sine-wave pattern according to an embodiment;

FIG. 15 illustrates how phase is determined from a set of shifted sine waves according to an embodiment;

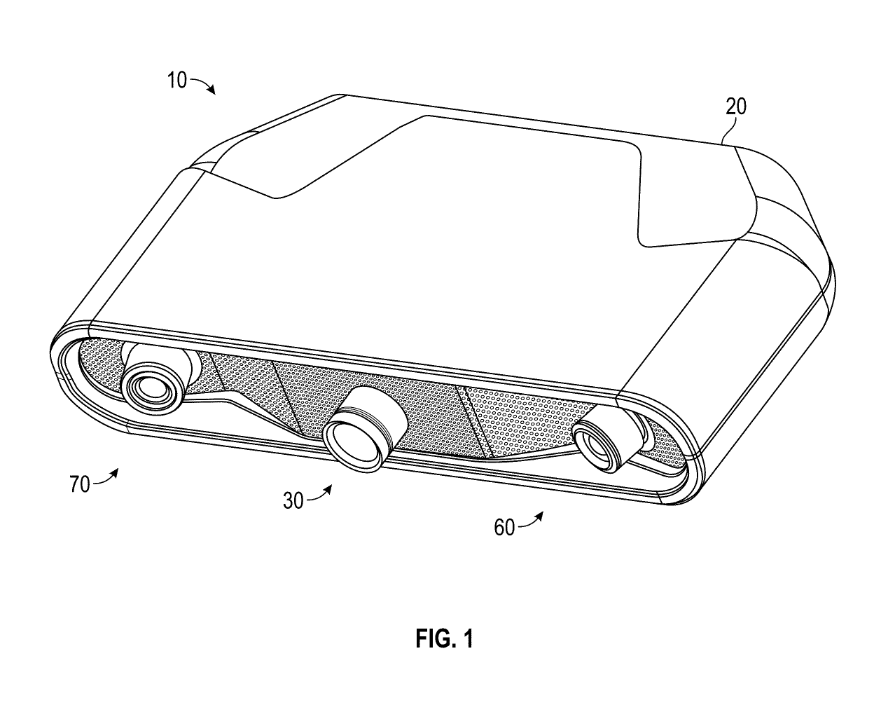

FIG. 16 a view of a point cloud data containing edge features measured with the 3D Imager of FIG. 1;

FIG. 17 is an enlarged portion of the point cloud data of FIG. 16;

FIG. 18 illustrates measurement of a hole with a 3D imager according to an embodiment;

FIG. 19 illustrates how the image size of the imaged hole changes with distance from a scanner camera;

FIG. 20 illustrates how a measured 2D image may be combined with measured 3D points to improve the representation of hole edges according to an embodiment;

FIG. 21 is a flow diagram of a method of identifying and triangulating corresponding pairs of points using sub-pixel edge identified in 2D snap image and its phase value according to an embodiment;

FIG. 22 is a flow diagram of a method of determining coordinates of edge points according to an embodiment;

FIG. 23 illustrates subpixels of a two-dimensional image of an edge feature according to an embodiment;

FIG. 24 is a schematic diagram of a phase map overlaid with edge points according to an embodiment;

FIG. 25 is an illustration of a point cloud of FIG. 16 with edge point data incorporated therein according to an embodiment;

FIG. 26 is an illustration of a point cloud with edge point data incorporated therein according to an embodiment; and

FIG. 27 is an illustration of the point cloud of FIG. 26 with gap filling of points between edge data and a surface point cloud.

The detailed description explains embodiments of the invention, together with advantages and features, by way of example with reference to the drawings.

### DETAILED DESCRIPTION

Embodiments of the present invention provide advantages in improving thermal stability and cooling and in enabling measurement of large objects with relatively high accuracy and high resolution at relatively high speeds.

FIG. 1 is a perspective view of a 3D imager 10 according to an embodiment. It includes a frame 20, a projector 30, a first camera assembly 60, and a second camera assembly 70.

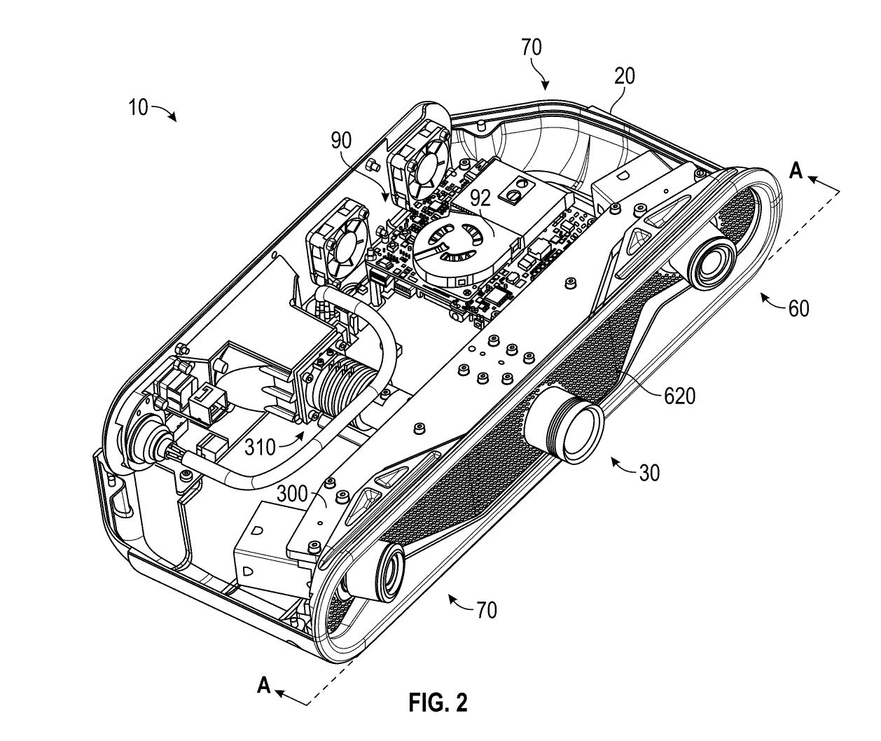

FIG. 2 and FIG. 3 show perspective views of internal elements 70 of the 3D imager 10. Internal elements are enclosed in a lower frame element 20. FIG. 3 shows elements of a projector-camera assembly 300 that includes projector-source assembly 310, projector 30, first camera-lens assembly 60, second camera-lens assembly 70, and support assembly 320. The support assembly 320 includes top structural support 322, bottom structural support 324, and web support 326. In addition, each camera includes mounting pins 328 and screws 329A, 329B.

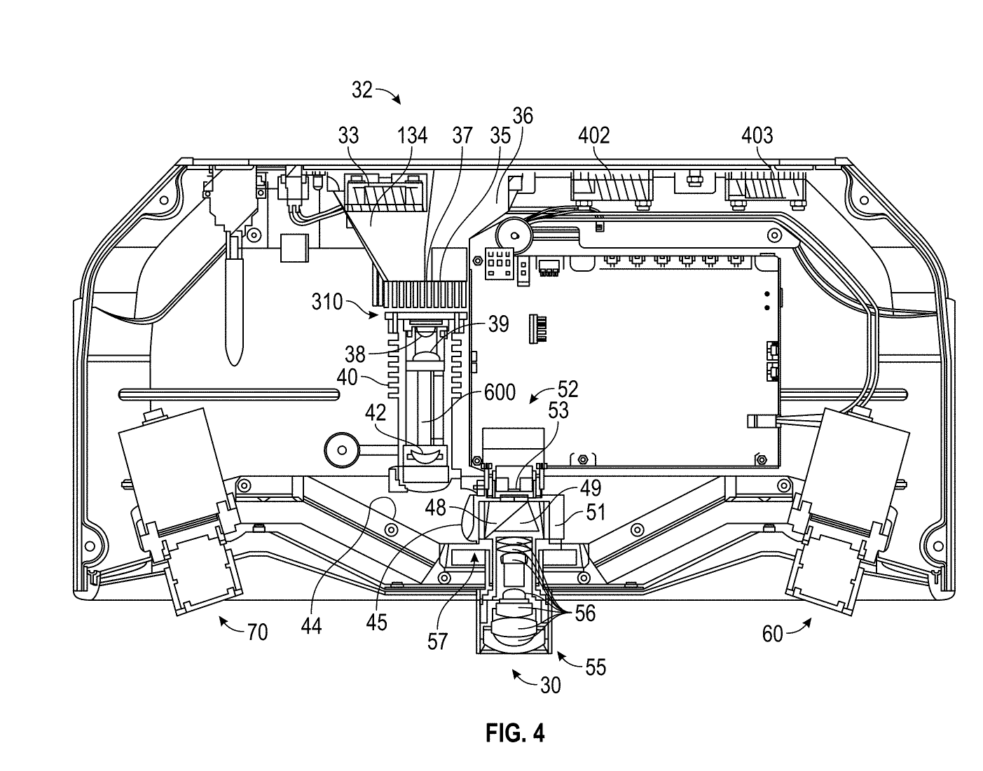

FIG. 4 is a top cross-sectional view of the 3D imager from FIG. 2. The projector lens assembly 30 includes a projector lens 55 and a projector lens mount 57. Projector lens 55 includes projector lens elements 56.

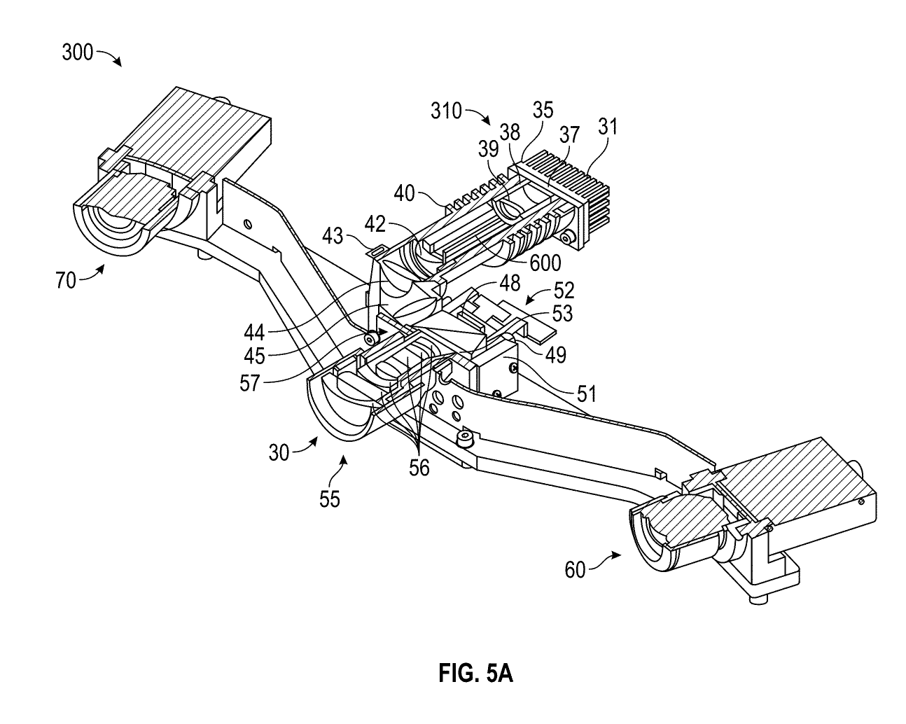

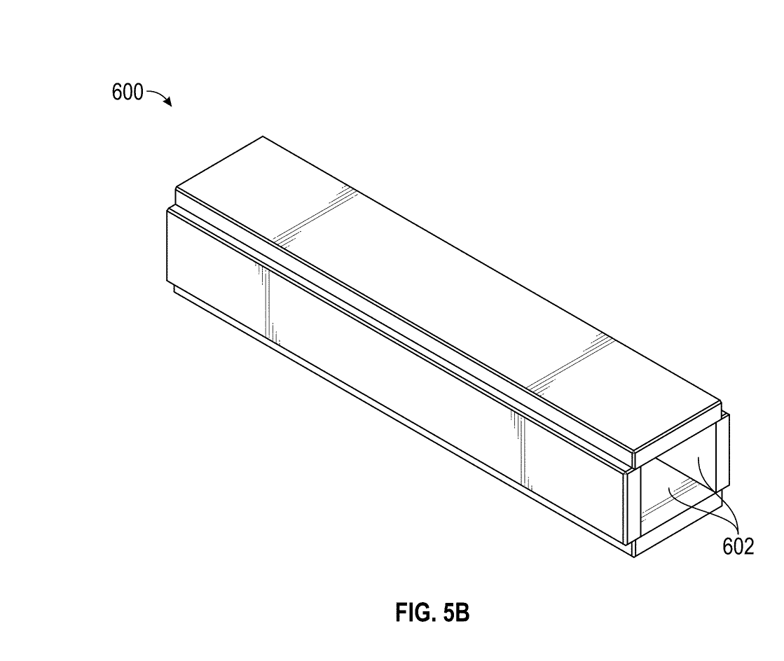

FIG. 5A, which is a cross-sectional view from FIG. 3, shows additional details of projector-source assembly 310 and pattern-projection assembly 52. In an embodiment, the projector-source assembly 310 includes light source 37, condensing lens elements 38, 39, light pipe 600, lenses 42, 43, 44, and mirror 44. In an embodiment, the light source 37 is an LED. The condensing lenses 38, 39 funnel light into the light pipe 600, which is shown in more detail in FIG. 5B. The light type reflects rays of light off reflective surfaces 602 in the light pipe 600. The purpose of the light pipe is to improve the homogeneity of the light from the condenser lenses 38, 39. Light passes through lenses 42 and 43 before reflecting off mirror 44 and passing through lens 45 into the pattern-projection assembly 52.

The pattern-projection assembly 52 includes a first prism 48, a second prism 49, and a digital micromirror device (DMD) 53. Together, the first prism 48 and second prism 49 comprise a total-internal-reflection (TIR) beam combiner. Light from lens 45 strikes an air interface between the first prism 48 and second prism 49. Because of the index of refraction of the glass in the first prism 48 and the angle of the first air interface relative to the light arriving from the lens 45, the light totally reflects toward the DMD 53. In the reverse direction, light reflected off the DMD 53 does not experience TIR and passes either out of the projector lens assembly 30 or onto a beam block 51. In an embodiment, the DMD 53 includes a large number of small micromechanical mirrors that rotate by a small angle of 10 to 12 degrees in either of two directions. In one direction, the light passes out of the projector 30. In the other direction, the light passes onto the beam block 51. Each mirror is toggled very quickly in such a way as to enable reflection of many shades of gray, from white to black. In an embodiment, the DMD chip produces 1024 shades of gray.

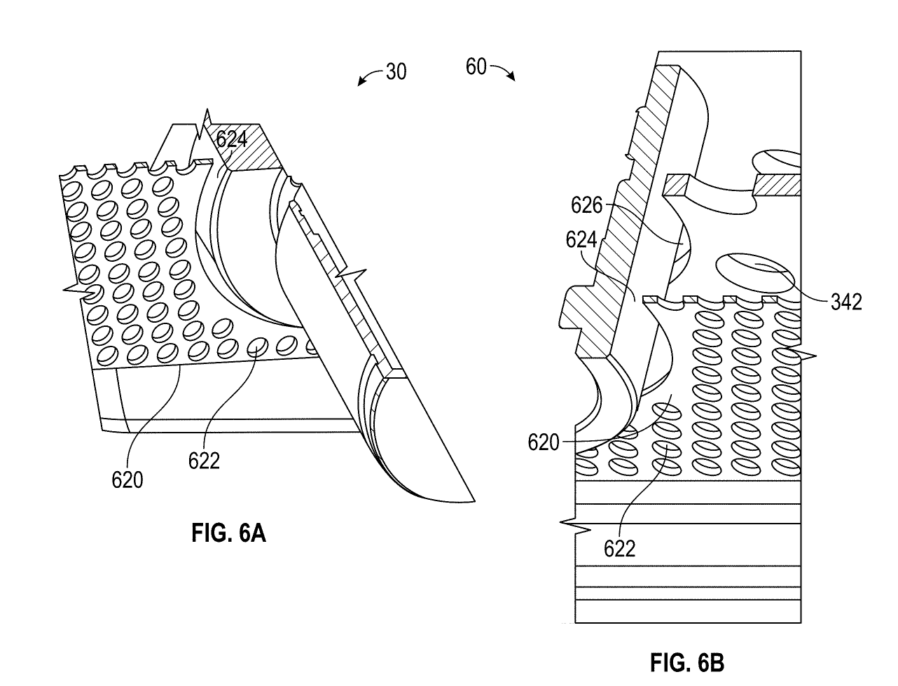

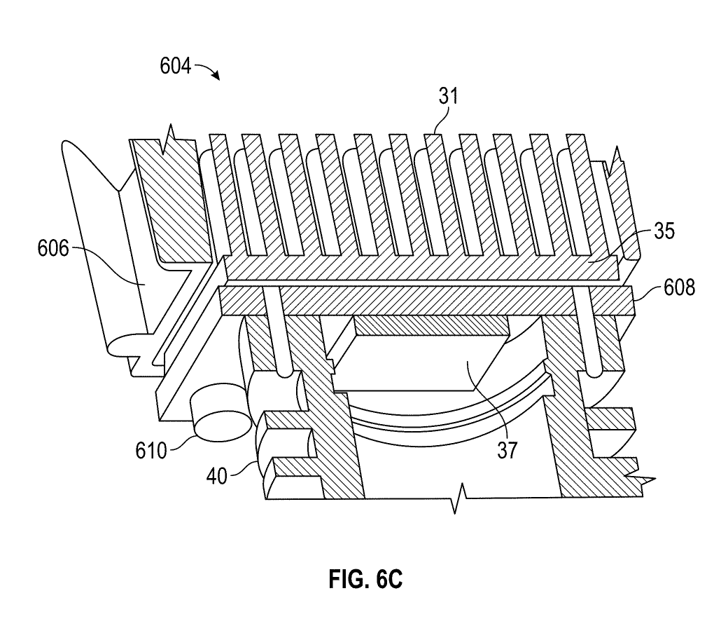

The light source assembly 37 is cooled by projector cooling system 32 shown in FIG. 4. The projector cooling system 32 includes fan 33, chambers 134, 36, and heat sinks 35, 40. In an embodiment, the heat sink 35 includes projections 31 having intervening air spaces, as shown in FIGS. 5A and 6C. In an embodiment, the fan 33 pushes air through chamber 134, through the air spaces separating the projections 31, into the chamber 36, and out the 3D imager 10 through a filtered exit in the frame 20. In this way, relatively cool outside air is forced past the heat sink projections 31, thereby removing heat generated by the light source 37 and stabilizing the temperature of the light source 37. In an embodiment illustrated in partial perspective view 604 in FIG. 6C, the light source 37 is an LED chip mounted to a heat sink element 608 that is in contact with the heat sink 31 and heat sink 40. The heat sink 31 may be in contact with a surrounding heat sink 606. In an embodiment, a temperature sensor 610 is attached to the heat sink 608 to enable monitoring of the LED temperature.

Elements within the frame 20 are cooled by fans 402 and 403 as shown in FIG. 4. The fans 402 and 403 pull air out of the cavity, first through holes 622 and openings 624 in a grill vent 620 surrounding the projector 30, the first camera assembly 60, and the second camera assembly 70. The air is pulled through additional openings and holes in the projector-camera assembly 300 such as the opening 340 and the web holes 342 shown in FIG. 3 and the opening 626 shown in FIG. 6B. The air drawn out of the frame 20 by the fans 402 and 403 provides cooling for the projector 30 and the camera assemblies 60, 70, as well as the heat sink 40 and other elements internal to the frame 20. As shown in FIG. 2, in an embodiment further cooling is provided for a circuit board 90 by a fan 92 that pumps heat from the circuit board out of the frame 20 through a dedicated duct.

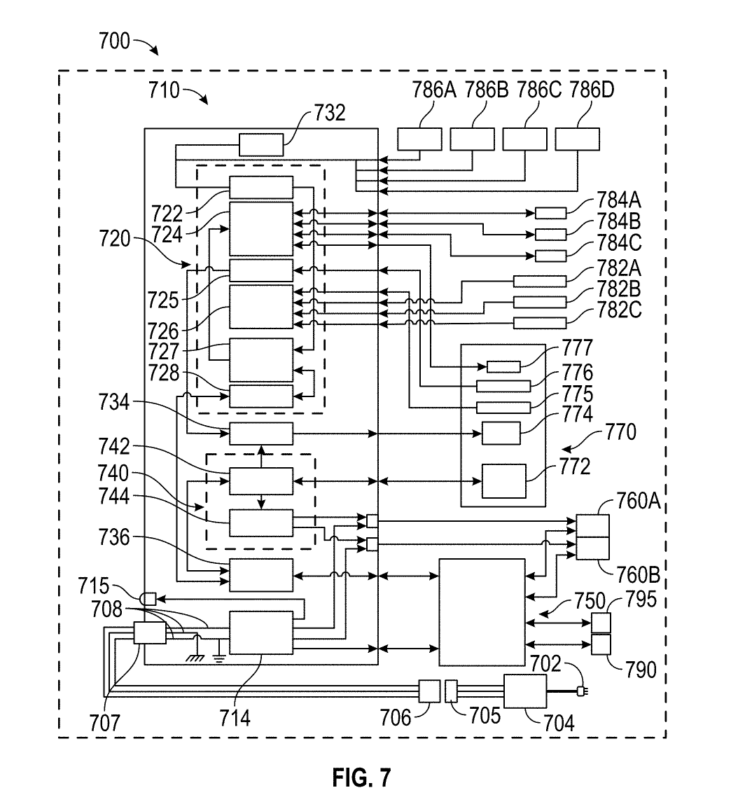

In an embodiment, the 3D imager includes internal electrical system 700 shown in FIG. 7. Internal electrical system 700 includes a Peripheral Component Interface (PCI) board 710, projector electronics 770, a processor board 750, and a collection of additional components discussed herein below. In an embodiment, the PCI board 710 includes a microcontroller integrated circuit 720, DMD controller chip 740, LED driver chip 734, an inertial measurement unit (IMU) chip 732, a Universal Serial Bus (USB) hub 736, and a power conversion component 714.

In an embodiment, the microcontroller integrated circuit 720 is a Programmable System-on-Chip (PSoC) by Cypress Semiconductor. The PSoC includes a central processing unit (CPU) core and mixed-signal arrays of configurable integrated analog and digital peripheral functions. In an embodiment, the microcontroller integrated circuit 720 is configured to serve as (1) a controller 724 for the fans 784A, 784B, and 784C, corresponding to fans 33, 402, and 403 in FIG. 4; (2) a controller for the LED driver chip 736; (3) an interface 726 for thermistor temperature sensors 782A, 782B, and 782C; (4) an inter-integrated circuit (I²C) interface 722; (5) an ARM microcontroller 727; and (6) a USB interface 728. The I²C interface 722 receives signals from the IMU chip 732 and I²C temperature sensors 786A, 786B, 786C, and 786D. It sends signals to an ARM microcontroller 727, which in turn sends signals to the fan controller 724. The DMD controller chip 740 sends high speed electrical pattern sequences to a DMD chip 772. It also sends output trigger signals to electronics 760A and 760B of the first camera assembly 60 and the second camera assembly 70, respectively. In an embodiment, the IMU includes a three-axis accelerometer and a three-axis gyroscope. In other embodiments, the IMU further includes an attitude sensor such as a magnetometer and an altitude sensor such as a barometer.

The projector electronics 770 includes fan electronics 777, projector photodiode 776, projector thermistor electronics 775, light source electronics 774, and DMD chip 772. In an embodiment, fan electronics 777 provides an electrical signal to influence the speed of the projector fan 33. The projector photodiode 776 measures an amount of optical power received by the DMD chip 772. The projector thermistor electronics 775 receives a signal from a thermistor temperature sensor such as the sensor 610 in FIG. 6C. The sensor 610 may provide a control signal in response. The light source electronics 774 may drive an LED chip 37. In an embodiment, the DMD is a DLP4500 device from Texas Instruments. This device includes 912 x 1140 micromirrors.

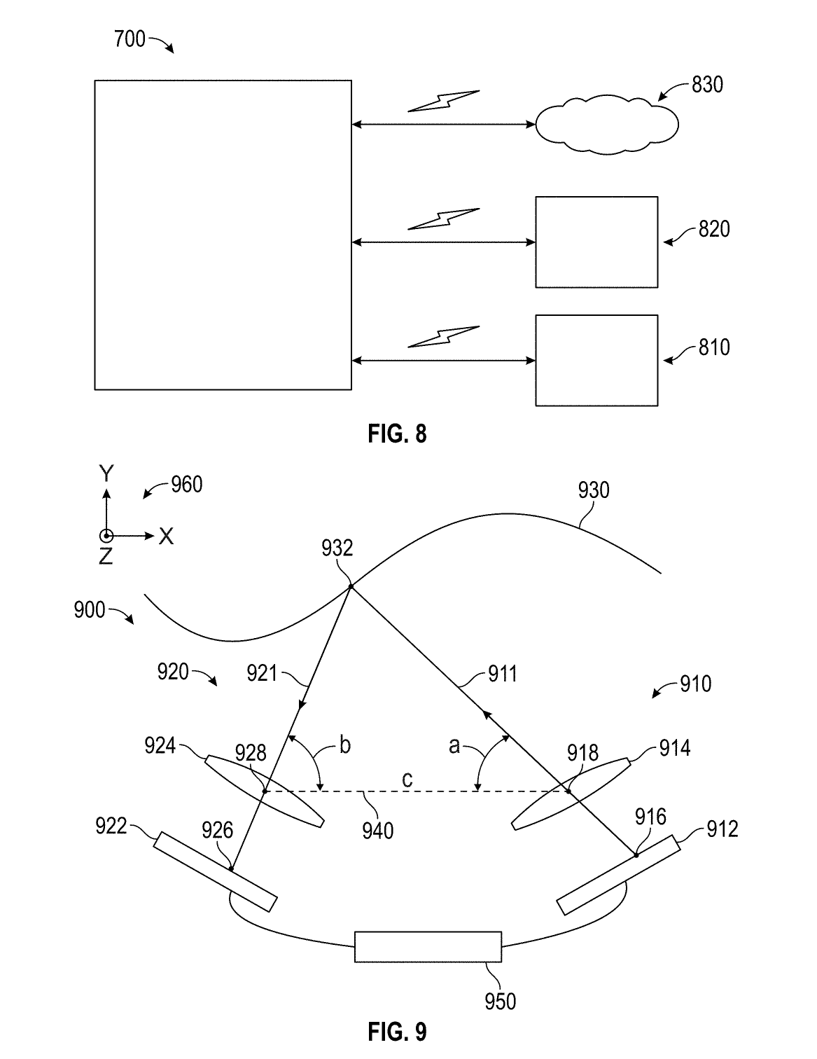

In an embodiment, the processor board 750 is a Next Unit of Computing (NUC) small form factor PC by Intel. In an embodiment, the processor board 750 is on the circuit board 90, which includes an integrated fan header 92, as shown in FIG. 1. In an embodiment, the processor board 750 communicates with camera assemblies 60 and 70 over electronics 760A, 760B via USB 3.0. The processor board 750 performs phase and triangulation calculations as discussed herein below and sends the results over USB 3.0 to the USB 2.0 hub 736, which shares signals with the DMD controller chip 740 and the USB interface 728. The processor board 750 may perform additional functions such as filtering of data or it may send partly processed data to additional computing elements, as explained herein below with reference to FIG. 8. In an embodiment, the processor board 750 further includes a USB 3.0 jack and an RJ45 jack.

In an embodiment, a DC adapter 704 attached to an AC mains plug 702 provides DC power through a connector pair 705, 706 and a socket 707 to the 3D imager 10. Power enters the frame 20 over the wires 708 and arrives at the power conversion component 714, which down-converts the DC voltages to desired levels and distributes the electrical power to components in the internal electrical system 700. One or more LEDs 715 may be provided to indicate status of the 3D imager 10.

FIG. 8 is a block diagram of a computing system that includes the internal electrical system 700, one or more computing elements 810, 820, and a network of computing elements 830, commonly referred to as the cloud. The cloud may represent any sort of network connection (e.g., the worldwide web or internet). Communication among the computing (processing and memory) components may be wired or wireless. Examples of wireless communication methods include IEEE 802.11 (Wi-Fi), IEEE 802.15.1 (Bluetooth), and cellular communication (e.g., 3G and 4G). Many other types of wireless communication are possible. A popular type of wired communication is IEEE 802.3 (Ethernet). In some cases, multiple external processors, especially processors on the cloud, may be used to process scanned data in parallel, thereby providing faster results, especially where relatively time-consuming registration and filtering may be required.

FIG. 9 shows a structured light triangulation scanner 900 that projects a pattern of light over an area on a surface 930. The scanner, which has a frame of reference 960, includes a projector 910 and a camera 920. The projector 910 includes an illuminated projector pattern generator 912, a projector lens 914, and a perspective center 918 through which a ray of light 911 emerges. The ray of light 911 emerges from a corrected point 916 having a corrected position on the pattern generator 912. In an embodiment, the point 916 has been corrected to account for aberrations of the projector, including aberrations of the lens 914, in order to cause the ray to pass through the perspective center, thereby simplifying triangulation calculations.

The ray of light 911 intersects the surface 930 in a point 932, which is reflected (scattered) off the surface and sent through the camera lens 924 to create a clear image of the pattern on the surface 930 on the surface of a photosensitive array 922. The light from the point 932 passes in a ray 921 through the camera perspective center 928 to form an image spot at the corrected point 926. The image spot is corrected in position to correct for aberrations in the camera lens. A correspondence is obtained between the point 926 on the photosensitive array 922 and the point 916 on the illuminated projector pattern generator 912. As explained herein below, the correspondence may be obtained by using a coded or an uncoded (sequentially projected) pattern. Once the correspondence is known, the angles a and b in FIG. 9 may be determined. The baseline 940, which is a line segment drawn between the perspective centers 918 and 928, has a length C. Knowing the angles a, b and the length C, all the angles and side lengths of the triangle 928-932-918 may be determined. Digital image information is transmitted to a processor 950, which determines 3D coordinates of the surface 930. The processor 950 may also instruct the illuminated pattern generator 912 to generate an appropriate pattern. The processor 950 may be located within the scanner assembly, or it may be an external computer, or a remote server.

As used herein, the term “pose” refers to a combination of a position and an orientation. In embodiment, the position and the orientation are desired for the camera and the projector in a frame of reference of the 3D imager 900. Since a position is characterized by three translational degrees of freedom (such as x, y, z) and an orientation is composed of three orientational degrees of freedom (such as roll, pitch, and yaw angles), the term pose defines a total of six degrees of freedom. In a triangulation calculation, a relative pose of the camera and the projector are desired within the frame of reference of the 3D imager. As used herein, the term “relative pose” is used because the perspective center of the camera or the projector can be located on an (arbitrary) origin of the 3D imager system; one direction (say the x axis) can be selected along the baseline; and one direction can be selected perpendicular to the baseline and perpendicular to an optical axis. In most cases, a relative pose described by six degrees of freedom is sufficient to perform the triangulation calculation. For example, the origin of a 3D imager can be placed at the perspective center of the camera. The baseline (between the camera perspective center and the projector perspective center) may be selected to coincide with the x axis of the 3D imager. The y axis may be selected perpendicular to the baseline and the optical axis of the camera. Two additional angles of rotation are used to fully define the orientation of the camera system. Three additional angles or rotation are used to fully define the orientation of the projector. In this embodiment, six degrees-of-freedom define the state of the 3D imager: one baseline, two camera angles, and three projector angles. In other embodiment, other coordinate representations are possible.

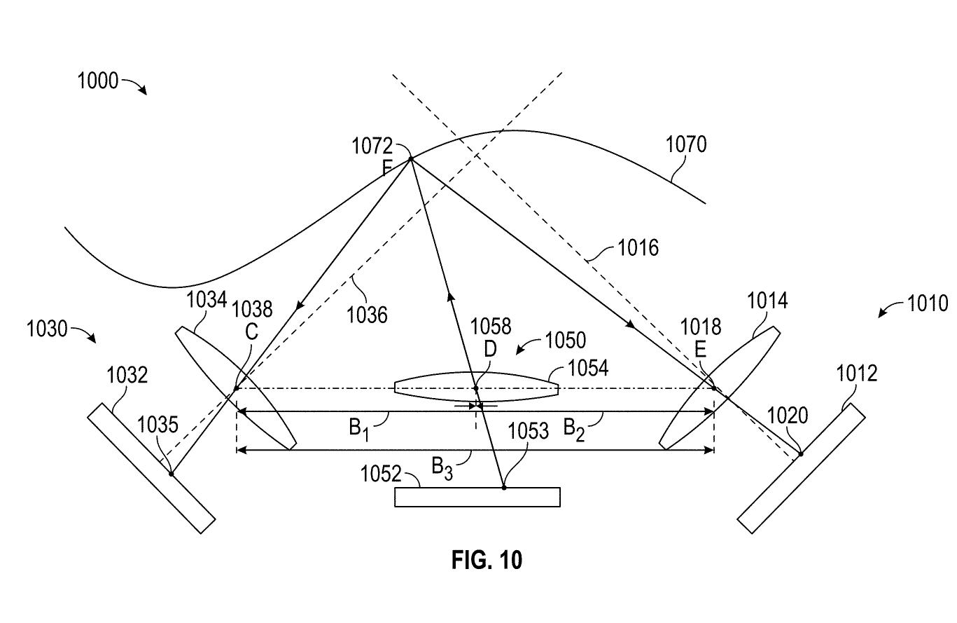

FIG. 10 shows a structured light triangulation scanner 1000 having a projector 1050, a first camera 1010, and a second camera 1030. The projector creates a pattern of light on a pattern generator plane 1052, which it projects from a corrected point 1053 on the pattern through a perspective center 1058 (point D) of the lens 1054 onto an object surface 1070 at a point 1072 (point F). The point 1072 is imaged by the first camera 1010 by receiving a ray of light from the point 1072 through a perspective center 1018 (point E) of a lens 1014 onto the surface of a photosensitive array 1012 of the camera as a corrected point 1020. The point 1020 is corrected in the read-out data by applying a correction factor to remove the effects of lens aberrations. The point 1072 is likewise imaged by the second camera 1030 by receiving a ray of light from the point 1072 through a perspective center 1038 (point C) of the lens 1034 onto the surface of a photosensitive array 1032 of the second camera as a corrected point 1035.

The inclusion of two cameras 1010 and 1030 in the system 1000 provides advantages over the device of FIG. 9 that includes a single camera. One advantage is that each of the two cameras has a different view of the point 1072 (point F). Because of this difference in viewpoints, it is possible in some cases to see features that would otherwise be obscured—for example, seeing into a hole or behind a blockage. In addition, it is possible in the system 1000 of FIG. 10 to perform three triangulation calculations rather than a single triangulation calculation, thereby improving measurement accuracy. A first triangulation calculation can be made between corresponding points in the two cameras using the triangle CEF with the baseline B₃. A second triangulation calculation can be made based on corresponding points of the first camera and the projector using the triangle DEF with the baseline B₂. A third triangulation calculation can be made based on corresponding points of the second camera and the projector using the triangle CDF with the baseline B₁. The optical axis of the first camera 1020 is 1016, and the optical axis of the second camera 1030 is 1036.

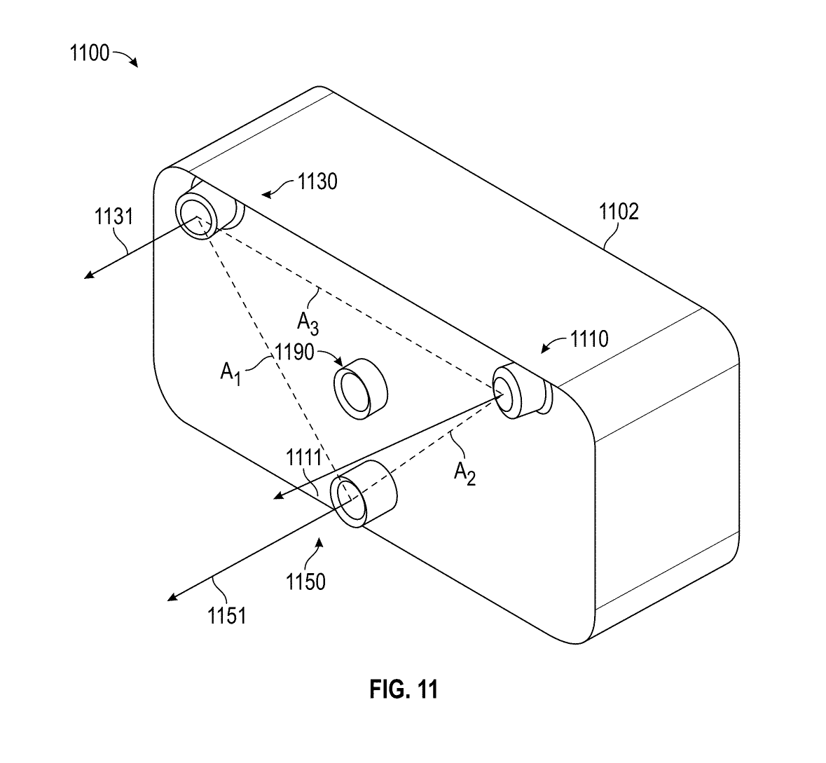

FIG. 11 shows 3D imager 1100 having two cameras 1110, 1130 and a projector 1150 arranged in a triangle A₁-A₂-A₃. In an embodiment, the 3D imager 1100 of FIG. 11 further includes a camera 1190 that may be used to provide color (texture) information for incorporation into the 3D image. In addition, the camera 1190 may be used to register multiple 3D images through the use of videogrammetry.

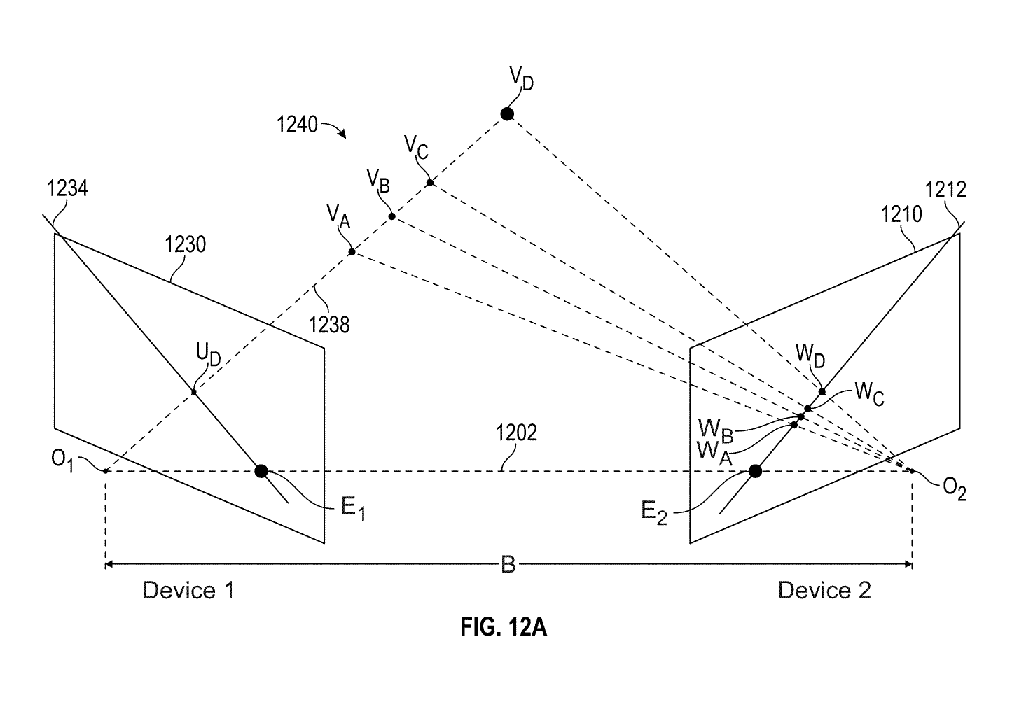

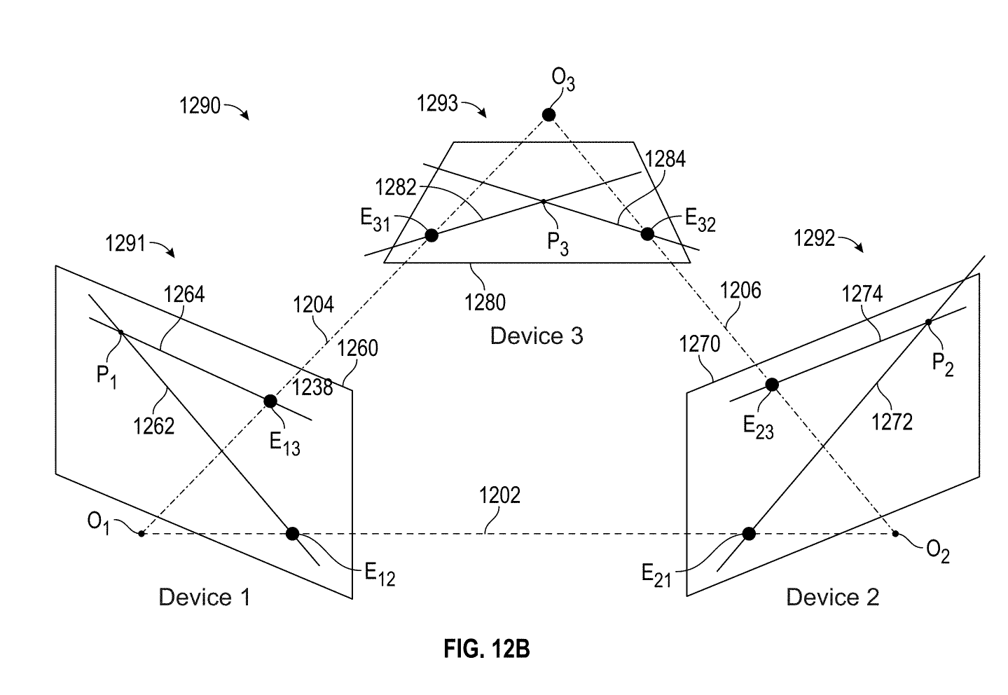

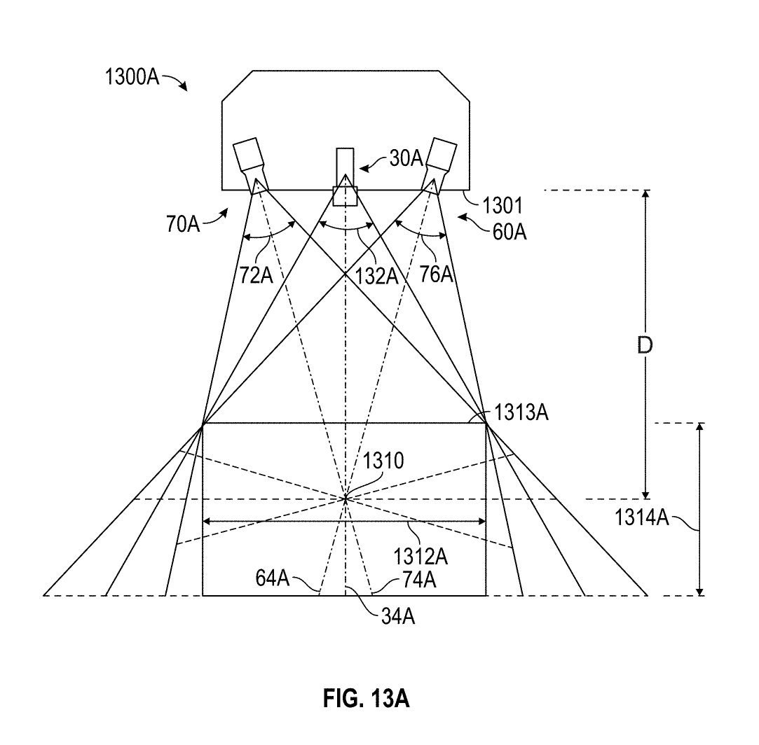

This triangular arrangement provides additional information beyond that available for two cameras and a projector arranged in a straight line as illustrated in FIGS. 1 and 10. The additional information may be understood in reference to FIG. 12A, which explain the concept of epipolar constraints, and FIG. 12B that explains how epipolar constraints are advantageously applied to the triangular arrangement of the 3D imager 1100. In FIG. 12A, a 3D triangulation instrument 1240 includes a device 1 and a device 2 on the left and right sides of FIG. 12A, respectively. Device 1 and device 2 may be two cameras or device 1 and device 2 may be one camera and one projector. Each of the two devices, whether a camera or a projector, has a perspective center, O₁ and O₂, and a representative plane, 1230 or 1210. The perspective centers are separated by a baseline distance B, which is the length of the line 1202. The concept of perspective center is discussed in more detail in reference to FIGS. 13C, 13D, and 13E. In other words, the perspective centers O₁, O₂ are points through which rays of light may be considered to travel, either to or from a point on an object. These rays of light either emerge from an illuminated projector pattern, such as the pattern on illuminated projector pattern generator 912 of FIG. 9, or impinge on a photosensitive array, such as the photosensitive array 922 of FIG. 9. As can be seen in FIG. 9, the lens 914 lies between the illuminated object point 932 and plane of the illuminated object projector pattern generator 912. Likewise, the lens 924 lies between the illuminated object point 932 and the plane of the photosensitive array 922, respectively. However, the pattern of the front surface planes of devices 912 and 922 would be the same if they were moved to appropriate positions opposite the lenses 914 and 924, respectively. This placement of the reference planes 1230, 1210 is applied in FIG. 12A, which shows the reference planes 1230, 1210 between the object point and the perspective centers O₁, O₂.

In FIG. 12A, for the reference plane 1230 angled toward the perspective center O₂ and the reference plane 1210 angled toward the perspective center O₁, a line 1202 drawn between the perspective centers O₁ and O₂ crosses the planes 1230 and 1210 at the epipole points E₁, E₂, respectively. Consider a point U_{D} on the plane 1230. If device 1 is a camera, it is known that an object point that produces the point U_{D} on the image lies on the line 1238. The object point might be, for example, one of the points V_{A}, V_{B}, V_{C}, or V_{D}. These four object points correspond to the points W_{A}, W_{B}, W_{C}, W_{D}, respectively, on the reference plane 1210 of device 2. This is true whether device 2 is a camera or a projector. It is also true that the four points lie on a straight line 1212 in the plane 1210. This line, which is the line of intersection of the reference plane 1210 with the plane of O₁-O₂-U_{D}, is referred to as the epipolar line 1212. It follows that any epipolar line on the reference plane 1210 passes through the epipole E₂. Just as there is an epipolar line on the reference plane of device 2 for any point on the reference plane of device 1, there is also an epipolar line 1234 on the reference plane of device 1 for any point on the reference plane of device 2.

FIG. 12B illustrates the epipolar relationships for a 3D imager 1290 corresponding to 3D imager 1100 of FIG. 11 in which two cameras and one projector are arranged in a triangular pattern. In general, the device 1, device 2, and device 3 may be any combination of cameras and projectors as long as at least one of the devices is a camera. Each of the three devices 1291, 1292, 1293 has a perspective center O₁, O₂, O₃, respectively, and a reference plane 1260, 1270, and 1280, respectively. Each pair of devices has a pair of epipoles. Device 1 and device 2 have epipoles E₁₂, E₂₁ on the planes 1260, 1270, respectively. Device 1 and device 3 have epipoles E₁₃, E₃₁, respectively on the planes 1260, 1280, respectively. Device 2 and device 3 have epipoles E₂₃, E₃₂ on the planes 1270, 1280, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

Consider the situation of FIG. 12B in which device 3 is a projector, device 1 is a first camera, and device 2 is a second camera. Suppose that a projection point P₃, a first image point P₁, and a second image point P₂ are obtained in a measurement. These results can be checked for consistency in the following way.

To check the consistency of the image point P₁, intersect the plane P₃-E₃₁-E₁₃ with the reference plane 1260 to obtain the epipolar line 1264. Intersect the plane P₂-E₂₁-E₁₂ to obtain the epipolar line 1262. If the image point P₁ has been determined consistently, the observed image point P₁ will lie on the intersection of the determined epipolar lines 1262 and 1264.

To check the consistency of the image point P₂, intersect the plane P₃-E₃₂-E₂₃ with the reference plane 1270 to obtain the epipolar line 1274. Intersect the plane P₁-E₁₂-E₂₁ to obtain the epipolar line 1272. If the image point P₂ has been determined consistently, the observed image point P₂ will lie on the intersection of the determined epipolar lines 1272 and 1274.

To check the consistency of the projection point P₃, intersect the plane P₂-E₂₃-E₃₂ with the reference plane 1280 to obtain the epipolar line 1284. Intersect the plane P₁-E₁₃-E₃₁ to obtain the epipolar line 1282. If the projection point P₃ has been determined consistently, the projection point P₃ will lie on the intersection of the determined epipolar lines 1282 and 1284.

The redundancy of information provided by using a 3D imager 1100 having a triangular arrangement of projector and cameras may be used to reduce measurement time, to identify errors, and to automatically update compensation/calibration parameters.

An example is now given of a way to reduce measurement time. As explained herein below in reference to FIGS. 14A-D and FIG. 15, one method of determining 3D coordinates is by performing sequential measurements. An example of such a sequential measurement method described herein below is to project a sinusoidal measurement pattern three or more times, with the phase of the pattern shifted each time. In an embodiment, such projections may be performed first with a coarse sinusoidal pattern, followed by a medium-resolution sinusoidal pattern, followed by a fine sinusoidal pattern. In this instance, the coarse sinusoidal pattern is used to obtain an approximate position of an object point in space. The medium-resolution and fine patterns used to obtain increasingly accurate estimates of the 3D coordinates of the object point in space. In an embodiment, redundant information provided by the triangular arrangement of the 3D imager 1100 eliminates the step of performing a coarse phase measurement. Instead, the information provided on the three reference planes 1260, 1270, and 1280 enables a coarse determination of object point position. One way to make this coarse determination is by iteratively solving for the position of object points based on an optimization-type procedure. For example, in one such procedure, a sum of squared residual errors is reduced or minimized to select the best-guess positions for the object points in space.

The triangular arrangement of 3D imager 1100 may also be used to help identify errors. For example, a projector 1293 in a 3D imager 1290 may project a coded pattern onto an object in a single shot with a first element of the pattern having a projection point P₃. The first camera 1291 may associate a first image point P₁ on the reference plane 1260 with the first element. The second camera 1292 may associate the first image point P₂ on the reference plane 1270 with the first element. The six epipolar lines may be generated from the three points P₁, P₂, and P₃ using the method described herein above. The intersection of the epipolar lines lie on the corresponding points P₁, P₂, and P₃ for the solution to be consistent. If the solution is not consistent, additional measurements of other actions may be advisable.

The triangular arrangement of the 3D imager 1100 may also be used to automatically update compensation/calibration parameters. Compensation parameters are numerical values stored in memory, for example, in the internal electrical system 700 or in another external computing unit. Such parameters may include the relative positions and orientations of the cameras and projector in the 3D imager.

The compensation parameters may relate to lens characteristics such as lens focal length and lens aberrations. They may also relate to changes in environmental conditions such as temperature. Sometimes the term calibration is used in place of the term compensation. Often compensation procedures are performed by the manufacturer to obtain compensation parameters for a 3D imager. In addition, compensation procedures are often performed by a user. User compensation procedures may be performed when there are changes in environmental conditions such as temperature. User compensation procedures may also be performed when projector or camera lenses are changed or after then instrument is subjected to a mechanical shock. Typically user compensations may include imaging a collection of marks on a calibration plate.

Inconsistencies in results based on epipolar calculations for a 3D imager 1290 may indicate a problem in compensation parameters. In some cases, a pattern of inconsistencies may suggest an automatic correction that can be applied to the compensation parameters. In other cases, the inconsistencies may indicate that user compensation procedures should be performed.

FIGS. 13A and 13B show two versions 1300A and 1300B, respectively, of the 3D imager 10. The 3D imager 1300A includes relatively wide FOV projector and camera lenses, while the 3D imager 1300B includes relatively narrow FOV projector and camera lenses. The FOVs of the wide-FOV cameras 70A, 60A and projector 30A of FIG. 13A are 72A, 62A, and 132A, respectively. The FOVs of the narrow-FOV cameras 70B, 60B and projector 30B of FIG. 13B are 72B, 62B, 132B, respectively. The standoff distance D of the 3D imager 1300A is the distance from the front 1301 of the scanner body to the point of intersection 1310 of the optical axes 74A and 64A of the camera lens assemblies 70A and 70B, respectively, with the optical axis 34A of the projector 30A. In an embodiment, the standoff distance D of the 3D imager 1300B is the same as the standoff distance D of the 3D imager 1300A. This occurs when the optical axis 74B of the lens assembly 70B is the same as the optical axis 74A of the lens assembly 70A, which is to say that the assemblies 70A and 70B are pointed in the same direction. Similarly, the optical axes 34B and 34A have the same direction, and the optical axes 64A and 64B have the same direction. Because of this, the optical axes of the 3D imagers 1300A and 1300B intersect at the same point 1310. To achieve this result, lens assemblies 30A, 60A, and 70A are designed and constructed to be interchangeable without requiring fitting to each particular frame 10. This enables a user to purchase a lens off the shelf that is compatible with the configuration of imager 1300A, imager 1300B, or other compatible imagers. In addition, in an embodiment, such replacement lenses may be purchased without requiring adjustment of the lens to accommodate variations in the 3D imager. The method of achieving this compatibility is described in more detail herein below in reference to FIGS. 18, 19A-C, 20A-B, and 21A-C.

Because the nominal standoff distance D is the same for 3D imagers 1300A and 1300B, the narrow-FOV camera lenses 60B and 70B have longer focal lengths than the wide-FOV camera lenses 60A and 70A if the photosensitive array is the same size in each case. In addition, as shown in FIGS. 13A and 13B, the width 1312B of the measurement region 1313B is smaller than the width 1312A of the measurement region 1312A. In addition, if the diameters of lens apertures are the same in each case, the depth 1314B (the depth of field (DOF)) of the measurement region 1313B is smaller than the depth 1314A (DOF) of the measurement region 1313A. In an embodiment, 3D imagers 10 are available with different fields of view and different image sensor resolution and size.

FIG. 13C shows a cross-sectional schematic representation 1300C of a camera assembly 70 and a projector 30 according to an embodiment. The camera lens assembly 70 includes a perspective center 1376, which is the center of the lens entrance pupil. The entrance pupil is defined as the optical image of the physical aperture stop as seen through the front of the lens system. The ray that passes through the center of the entrance pupil is referred to as the chief ray, and the angle of the chief ray indicates the angle of an object point as received by the camera. A chief ray may be drawn from each illuminated point on the object through the entrance pupil. For example, the ray 1381 is a chief ray that defines the angle of an object point (on the ray) with respect to the camera lens 1371. This angle is defined with respect to an optical axis 74 of the lens 3171.

The exit pupil is defined as the optical image of the physical aperture stop as seen through the back of the lens system. The point 1377 is the center of the exit pupil. The chief ray travels from the point 1377 to a point on the photosensitive array 1373. In general, the angle of the chief ray as it leaves the exit pupil is different than the angle of the chief ray as it enters the perspective center (the entrance pupil). To simplify analysis, the ray path following the entrance pupil is adjusted to enable the beam to travel in a straight line through the perspective center 1376 to the photosensitive array 1373 as shown in FIGS. 13D and 13E. Three mathematical adjustments are made to accomplish this. First, the position of each imaged point on the photosensitive array is corrected to account for lens aberrations and other systematic error conditions. This may be done by performing compensation measurements of the lenses in the cameras 70, 60 and the projector 30. Such compensation measurement may include, for example, measuring a calibration dot plate in a prescribed arrangement and sequence to obtain aberration coefficients or an aberration map for the lenses. Second, the angle of the ray 1382 is changed to equal the angle of the ray 1381 that passes through the perspective center 1376. The distance from the exit pupil 1377 to the photosensitive array 1373 is adjusted accordingly to place the image points at the aberration-corrected points on the photosensitive array 1373. Third, the point 1377 is collapsed onto the perspective center to remove the space 1384, enabling all rays of light 1381 emerging from the object to pass a straight line through the point 1376 onto the photosensitive array 1373, as shown in FIG. 13E. By this means, the exact path of each beam of light passing through the optical system of the camera 70C may be simplified for rapid mathematical analysis by the electrical circuit and processor 1374 in a mount assembly 1372. In the discussion herein below, the term perspective center is taken to be the center of the entrance pupil with the lens model revised to enable rays to be drawn straight through the perspective center to a camera photosensitive array or straight through the perspective center to direct rays from a projector pattern generator device.

Referring again to FIG. 13C, the projector assembly 3C has a perspective center 1336, a center of an exit pupil 1337, an optical axis 34, and a projector pattern array 1333. As in the camera assembly 70, mathematical corrections are made to enable a ray from light 1341 to travel straight through the perspective center 1336 from the projector pattern plane 1333 to an object. In an embodiment, the projector pattern array 1333 is the DMD 53 shown in FIG. 5A.

An explanation is now given for a known method of determining 3D coordinate on an object surface using a sinusoidal phase-shift method, as described with reference to FIGS. 14A-D and FIG. 15. FIG. 14A illustrates projection of a sinusoidal pattern by the projector 30A. In an embodiment, the sinusoidal pattern in FIG. 14A varies in optical power from completely dark to completely bright. A low or minimum position on the sine wave in FIG. 14A corresponds to a dark projection and a highest or maximum position on the sine wave corresponds to a bright projection. The projector 30A projects light along rays that travel in constant lines emerging from the perspective center of the projector lens. Hence in FIG. 14A, a line along the optical axis 34A in FIG. 14A represents a point neither at a maximum or minimum of the sinusoidal pattern and hence represents an intermediate brightness level. The relative brightness will be the same for all points lying on a ray projected through the perspective center of the projector lens. So, for example, all points along the ray 1415 are at a high or maximum brightness level of the sinusoidal pattern. A complete sinusoidal pattern occurs along the lines 1410, 1412, and 1414, even though the lines 1410, 1412, and 1414 have different lengths.

In FIG. 14B, a given pixel of a camera 70A may see any of a collection of points that lie along a line drawn from the pixel through the perspective center of the camera lens assembly. The actual point observed by the pixel will depend on the object point intersected by the line. For example, for a pixel aligned to the optical axis 74A of the lens assembly 70A, the pixel may see a point 1420, 1422, or 1424, depending on whether the object lies along the lines of the patterns 1410, 1412, or 1414, respectively. Notice that in this case the position on the sinusoidal pattern is different in each of these three cases. In this example, the point 1420 is brighter than the point 1422, which is brighter than the point 1424.

FIG. 14C illustrates projection of a sinusoidal pattern by the projector 30A, but with more cycles of the sinusoidal pattern projected into space. FIG. 14C illustrates the case in which ten sinusoidal cycles are projected rather than one cycle. The cycles 1430, 1433, and 1434 are projected at the same distances from the scanner 1400 as the lines 1410, 1412, and 1414, respectively, in FIG. 14A. In addition, FIG. 14C shows an additional sinusoidal pattern 1433.

In FIG. 14D, a pixel aligned to the optical axis 74A of the lens assembly 70A sees the optical brightness levels corresponding to the positions 1440, 1442, 1444, and 1446 for the four sinusoidal patterns illustrated in FIG. 14D. Notice that the brightness level at a point 1440 is the same as at the point 1444. As an object moves farther away from the scanner 1400, from the point 1440 to the point 1444, it first gets slightly brighter at the peak of the sine wave, and then drops to a lower brightness level at position 1442, before returning to the original relative brightness level at 1444.

In a phase-shift method of determining distance to an object, a sinusoidal pattern is shifted side-to-side in a sequence of at least three phase shifts. For example, consider the situation illustrated in FIG. 15. In this figure, a point 1502 on an object surface 1500 is illuminated by the projector 30A. This point is observed by the camera 70A and the camera 60A. Suppose that the sinusoidal brightness pattern is shifted side-to-side in four steps to obtained shifted patterns 1512, 1514, 1516, and 1518. At the point 1502, each of the cameras 70A and 60A measure the relative brightness level at each of the four shifted patterns. If for example the phases of the sinusoids for the four measured phases are θ={160°, 250°, 340°, 70°} for the positions 1522, 1524, 1526, and 1528, respectively, the relative brightness levels measured by the cameras 70A and 60A at these positions are (1+sin (θ))/2, or 0.671, 0.030, 0.329, and 0.969, respectively. A relatively low brightness level is seen at position 1424, and a relatively high brightness level is seen at the position 1528.

By measuring the amount of light received by the pixels in the cameras 70A and 60A, the initial phase shift of the light pattern 1512 can be determined. As suggested by FIG. 14D, such a phase shift enables determination of a distance from the scanner 1400, at least as long as the observed phases are known to be within a 360 degree phase range, for example, between the positions 1440 and 1444 in FIG. 14D. A quantitative method is known in the art for determining a phase shift by measuring relative brightness values at a point for at least three different phase shifts (side-to-side shifts in the projected sinusoidal pattern). For a collection of N phase shifts of sinusoidal signals resulting in measured relative brightness levels xᵢ, a general expression for the phase ϕ is given by ϕ=tan⁻¹ (−bᵢ,/aᵢ)^{0.5}, where aᵢ=Σxⱼ cos(2πj/N) and bᵢ=πxⱼ sin(2πj/N), the summation being taken over integers from j=0 to N−1. For some embodiments, simpler formulas may be used. For example, for the embodiment of four measured phases each shifted successively by 90 degrees, the initial phase value is given by tan⁻¹ ((x₄−x₂)/(x₁−x₃)).

The phase shift method of FIG. 15 may be used to determine the phase to within one sine wave period, or 360 degrees. For a case such as in FIG. 14D wherein more than one 360 interval is covered, the procedure may further include projection of a combination of relatively coarse and relatively fine phase periods. For example, in an embodiment, the relatively coarse pattern of FIG. 14A is first projected with at least three phase shifts to determine an approximate distance to the object point corresponding to a particular pixel on the camera 70A. Next the relatively fine pattern of FIG. 14C is projected onto the object with at least three phase shifts, and the phase is determined using the formulas given above. The results of the coarse phase-shift measurements and fine phase-shift measurements are combined to determine a composite phase shift to a point corresponding to a camera pixel. If the geometry of the scanner 1500 is known, this composite phase shift is sufficient to determine the three-dimensional coordinates of the point corresponding to a camera pixel using the methods of triangulation, as discussed herein above with respect to FIG. 9. The term “unwrapped phase” is sometimes used to indicate a total or composite phase shift.

An alternative method of determining 3D coordinates using triangulation methods is by projecting coded patterns. If a coded pattern projected by the projector is recognized by the camera(s), then a correspondence between the projected and imaged points can be made. Because the baseline and two angles are known for this case, the 3D coordinates for the object point can be determined.

An advantage of projecting coded patterns is that 3D coordinates may be obtained from a single projected pattern, thereby enabling rapid measurement, which is desired for example in handheld scanners. One disadvantage of projecting coded patterns is that background light can contaminate measurements, reducing accuracy. The problem of background light is avoided in the sinusoidal phase-shift method since background light, if constant, cancels out in the calculation of phase.

One way to preserve accuracy using the phase-shift method while reducing (or in some embodiments minimizing) measurement time is to use a scanner having a triangular geometry, as in FIG. 11. The three combinations of projector-camera orientation provide redundant information that may be used to eliminate some of the ambiguous intervals. For example, the multiple simultaneous solutions possible for the geometry of FIG. 11 may eliminate the possibility that the object lies in the interval between the positions 1444 and 1446 in FIG. 14D. This knowledge may eliminate a step of performing a preliminary coarse measurement of phase, as illustrated for example in FIG. 14B. An alternative method that may eliminate some coarse phase-shift measurements is to project a coded pattern to get an approximate position of each point on the object surface.

One issue that sometimes arises with phase shift methods of determining distance is the determination of 3D coordinates of edges. Referring now to FIG. 16, a 3D point cloud data 1600 is shown for a plate having five holes 1602, 1604, 1606, 1608, 1610. An enlarged portion of the point cloud data 1600 is shown in FIG. 17 for a portion of the edges defining holes 1602, 1604. As seen in FIG. 17, the edges of the holes 1602, 1604 are not uniform, but rather are missing points in the point cloud data 1600 resulting in an uneven or “ragged” edge. There may be several reasons for the missing 3D coordinate points. In some instances, the 3D imager may not have received a sufficient reflection of light to determine a correspondence between the projector and the cameras for example. In other instances, the measured 3D coordinate point may not have passed one or more validation thresholds or otherwise returned invalid data. Such a problem is encountered, for example, when a single pixel captures a range of distance values, such as at the edge of a hole. Sometimes the term “mixed pixel” is used to refer to the case in which the distance ascribed to a single pixel on the final 3D image is determined by a plurality of distances to the object. For a mixed pixel, a 3D imager may determine the distance to a point as a simple average of the distances received by the pixel. In general, such simple averages can result in 3D coordinates that are off by a relatively large amount. In some cases, when a mixed pixel covers a wide range of distance values, it may happen that “ambiguity range” is exceeded during a phase shift calculation, resulting in a large error that is difficult to predict. In some of these instances, the questionable 3D coordinate point may be discarded from the point cloud data 1600.

Referring now to FIGS. 18-20 an embodiment of a method is shown for obtaining improved accuracy in determining 3D coordinates of edges through the use of a phase map generated from the 3D scanning of the object combined with a two-dimensional (2D) camera image. This provides advantages in improving the accuracy in determining 3D coordinates of edges.

In one embodiment, the issue of missing data points along sharp edges utilizes image data that is acquired in one or more 2D images of the feature being measured. In many cases, edge features can be clearly seen in 2D images—for example, based on textural shadings. As discussed herein, these sharp edges may be determined in coordination with surface coordinates determined using the triangulation methods. In one embodiment, shown in FIGS. 18-20, a method is provided for determining 3D coordinates of edge features by determining an intersection of projected rays that pass through the perspective center of the lens in the triangulation scanner with the 3D coordinates of the portion of the surface.

In the embodiment of FIGS. 18-20, an object 1802 is provided with a hole 1804. The cameras 60B, 70B of triangulation scanner 1300B capture the image of light projected by projector 30B onto the surface of the object 1802 and reflected off the object surface. The reflected rays of light pass through the perspective center of the camera lens onto a photosensitive array within the camera. The photosensitive array sends an electrical signal to an electrical circuit board that includes a processor for processing digital image data. Using methods of triangulation described herein above, the processor determines the 3D coordinates to each point on the object surface.

The 2D image may be from a triangulation camera such as 60B or 70B or from a separate camera. In an embodiment illustrated in FIG. 19, a system 1900 includes a camera 1910 that receives rays of light 1932 and 1934 from the edges of holes in objects. The hole may be a hole 1922A in an object 1920A located relatively close to the camera 1910 or a hole 1922B in an object 1920B located relatively far from the camera 1910. A projector 30 provides light to illuminate the object 1920A or 1920B. In an embodiment, it is known from a priori knowledge that the hole is bored into a relatively flat object. A 3D imager such as the imager 1300B may determine the distance to the object, enabling the system to distinguish between the relatively near object 1920A and the relatively far object. An image of the hole on the photosensitive array 1916 is analyzed by a processor such as the processor 1918 to identify the edges of the hole. A cone is generated when the edges of the hole are mathematically projected from the image plane 1916 through the perspective center 1914 of the camera 1910. The mathematical cone of light expands outward and intersects the plane of the object, which has surface coordinates determined by the 3D imager. In this way a mathematical calculation of the intersection of the plane of the object with the cone projected from the image plane 1916 through the perspective center 1914 provides an accurate shape and diameter of the hole. This method helps to avoid problems from mixed pixels in the 3D measured points near edges, as described herein above.

Referring to FIG. 20, the method may be further illustrated by considering the example of an object 2000 having a flat region 2010 into which is drilled a hole 2020. A region extends from the edge of hole 2020 to a peripheral boundary 2022 in which there is a relatively high level of uncertainty (e.g. due to a poor quality of phase map) because of mixed pixel effects or other effects such as edges that not sharp, for example, because of bevels or fillets. In an embodiment, 3D measurements are based entirely on scanner measurements for the region outside 2022. In this embodiment, the edges 2020 are determine by an intersection of the projected 2D image (e.g., a projected cone in the case of a hole) with the object surface 2010. The surface characteristics are maintained between the outer circle 2022 and the inner circle 2020. In the case discussed with respect to FIG. 20, the region between the circles 2020 and 2022 is assumed to be flat. In other situations, other assumptions may be made about the shape of the surface between regions such as 2022 and 2020.

Referring back to FIG. 18, the two cameras 60B and 70B may be used to obtain 3D coordinates by triangulation methods described herein above and also to identify edges in 2D camera images. By acquiring images of edges from each of two or more cameras, an object is seen from multiple directions, thereby reducing the number of hidden features.

Referring now to FIGS. 21-24, another embodiment of determining 3D coordinates of points along an edge is provided. A method 2100 is provided that uses one or more 2D camera images (such as cameras 60B, 70B of FIG. 18) to determine edge points of a feature such as a hole. In an embodiment, these edge points are determined at a subpixel level. It should be appreciated that while embodiments described herein may refer using two cameras for determining edge points, this is for exemplary purposes and the claimed invention should not be so limited. In other embodiments, the edge points may be determined by a pair of imaging devices, such as a single camera and a projector for example, provided that the epipolar relationship between the imaging devices is known.

The method 2100 starts in block 2102 where the object is scanned with a 3D imager using the phase shift method as described herein. In this embodiment, the object has one or more features, such as holes for example, that include edges. As discussed herein, the 3D imager, such as 3D imager 1300B for example, will have at least one camera that acquires two-dimensional images during the scanning process. The method 2100 then proceeds to block 2104 where a surface point cloud data is generated for the 3D coordinates of the measured points. For reasons described herein, some of the measured points for the edges may be either be missing or invalid (i.e. “mixed pixels”). In an embodiment, the phase of the invalid pixels are estimated since pixels marked as invalid in the phase map have no phase value associated with them. To identify these edges and improve the accuracy of the point cloud data, the method 2100 proceeds to block 2106 where the sub-pixel edges are identified in 2D images acquired by the 3D imager cameras. In the example of FIG. 24, the object being scanned has a hole 2400 that defines an edge. In each of the images 2402, 2410 acquired by the cameras 60B, 70B, the edges 2401, 2403 of the hole 2400 are identified. In an embodiment, after identifying the edges, the method proceeds to block 2107 where the phase map in the vicinity of the sub-pixel edge points is corrected. Phase values of the pixels marked as invalid and without phase values are estimated. In an embodiment, as a result of the correction of the phase map in the vicinity of sub-pixel edges, additional valid surface points in the vicinity of such identified sub-pixel edge points, resulting in filling of the gap between the sub-pixel edge points and the original surface. FIG. 26 and FIG. 27 illustrate the results without and with such gap filling of points.

With the edges 2401, 2403 identified, the method 2100 further identifies edge and edge points in the first 2D image 2402 (e.g. the left camera image). In an embodiment, the edge points are identified using a method 2200. First, the edge points are extracted from the subpixels of the 2D image 2402 in block 2202. The edge points may be determined from a 2D image using several methods, such as gradient based methods which determines points corresponding to a maxima of intensity profile in a direction normal to the edge. In other embodiments, methods of identifying edge points determine subpixel locations by weighting pixel locations in a direction normal to the edge by the intensity gradient.

In the exemplary embodiment, the edge points are determined by modeling the intensity values of pixels on either side of the edge 2401 by the areas of two regions. A process that uses this method in relation to 2D images is described in an article entitled “Accurate subpixel edge location based on partial area effect” by Agustin Trujillo-Pino et al. (J. Image and Vision Computing 31 (2013) 72-90), the contents of which are incorporated by reference herein. In this embodiment, for each subpixel a line estimating the edge is determined, such as a line 2302 (FIG. 23) for example. Next, a normal vector 2304 is used to identify pixel on the surface of the part in the vicinity of an edge so that if it's invalid and has no phase value, a phase value can be estimated for it thereby allowing for improved phase estimation at a subpixel edge point. In an embodiment, where the normal vector intersects the estimated edge line, an edge point is identified.

In the embodiment of FIG. 24, in the first image 2402 an edge point 2404 is identified using the method described herein. The location of the edge point 2404 is determined at the subpixel level (e.g. 73.567, 200.788). The method 2200 then proceeds to block 2204 where the phase value of edge point 2404 is determined. In one embodiment, a two-dimensional phase map defined during 3D point capture for the corresponding camera generated in block 2102. The sub-pixel edge point is projected onto the phase map and its phase value determined. In the embodiment of FIG. 24, the edge point 2404 lies on the phase line 2406.

The method 2200 then proceeds to block 2206 where in the phase map of the other camera a search is conducted on the epipolar line 2408 corresponding to the sub-pixel edge in the first camera to determine a corresponding sub-pixel point that has the same phase value as the subpixel in the first camera. In the embodiment of FIG. 24, an epipolar line 2408 in the second image 2410 (e.g. the “right” image“) is determined from the subpixel location of edge point 2404. A search is then performed in block 2208 on the epipolar line based on estimating a phase value using methods of interpolation in the vicinity of a point on the epipolar point In the embodiment of FIG. 24, a search is performed to identify a point 2414 based on epipolar line 2408 having an interpolated or extrapolated phase value that is the same as point 2404. In an embodiment, once the corresponding pairs of sub-pixels are identified, the coordinates of the edge points corresponding to the sub-pixels are determined in block 2210 using triangulation and epipolar geometry.

In an embodiment, during the search process for a corresponding sub-pixel in the image 2410 of the second device, given the first edge sub-pixel in the image 2402 of the first device, the search is conducted on the epipolar line corresponding to the first edge-sub-pixel in the image 2410 of the second device. A match is found when the phase value of the sub-pixel point in the image 2410 of the second device matches the phase value of the edge sub-pixel in the image 2402 of the first device within a tolerance parameter. In an embodiment, the tolerance parameter is about 0.0001 radians.

It should be appreciated that not all identified edge points will have corresponding physical points in the image 2410. For example, a point 2416 may be identified in the first image 2402. This may occur for example, if the point 2416 corresponds to a reflection from a scratch in image 2402—searching along epipolar line 2418 will return a point somewhere on iso-phase line 2424 in image 2410 which when triangulated with point 2416 will generate a point in the surface of the object. However, such contrast edge points are filtered out from the point cloud in block 2109 since the contrast edge point will have neighboring points on all sides (and therefore is not a physical edge). Similarly, a point 2420 may also be identified in the image 2402. Point 2420 might for example correspond to the inside of a wall, which is visible only in one camera and not in the other, and hence a search on the epipolar line will not return a point with a matching phase value in the other camera. Therefore, no corresponding points are found.

With the corresponding edge points 2404, 2414 identified in images 2402, 2410, the method 2100 then proceeds to block 2108 where triangulation methods are used with the subpixel pair (of the corresponding edge points 2404, 2414) to determine the 3D coordinates of the edge point (e.g. edge point 2404). This process is performed for each of the identified potential edge points in the first image 2402. The process is then repeated with image 2410 where a potential edge point is identified and a search is performed for a corresponding point in image 2402.

Once the edge points and their 3D coordinates are determined, these 3D coordinate points are added to the point cloud data resulting in an improved point cloud data with a more defined edge. An illustration of the combined point cloud data 2500 is shown in FIG. 25 that includes a plurality of points 2502 that define the edge of holes 1602, 1604, 1606, 1608, 1610.

In an embodiment, the edge points 2502 are flagged in the metadata of the point cloud data 2500. This provides advantages in allowing the user to determine the source of the data. The marking or flagging of the edge points 2502 also allows the edge points to be quickly identified and highlighted for the user, such as by changing the color of the edge points for example.

It should be appreciated that in some embodiments, the method of described with respect to FIGS. 18-20 is combined with the methods described with respect to FIGS. 21-25 to determine the 3D coordinates of edge points.

Technical effects and benefits of some embodiments include providing a method and a system that combining three-dimensional coordinate data with point data acquired from two dimensional images to provide a point cloud with improved edge definition over raw scan data acquired by phase-shift methods.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be appreciated that the methods of determining 3D coordinates of edge points described herein may be performed on the 3D imager, on a computing device coupled for communication to the 3D image (e.g. a cellular phone or a laptop computer) or may be performed by one or more processors connected in a distributed manner, such as via cloud computing for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for generating a point cloud of a scanned object, the method comprising:
determining a distance to each of a plurality of points on the object based at least in part on a phase shift of a light emitted from a coordinate measurement device having at least two image devices, wherein at least one of the image devices includes a first camera having an array of pixels;
generating a point cloud based at least in part on the distances to the plurality of points;
identifying an edge point from a two-dimensional image acquired by the first camera;
determining a corresponding point in the other image device based at least in part on a first phase value of the edge point and a epipolar relationship between the first camera and the image device;
determining the three-dimensional coordinates of the edge point and corresponding point based on triangulation; and
adding the edge point to the point cloud.

2. The method of claim 1, wherein the at least two image devices includes the first camera, a second camera and a projector arranged in a predetermined geometrical relationship.

3. The method of claim 2, further comprising acquiring a second two-dimensional image with the second camera.

4. The method of claim 3, wherein the determining a corresponding point includes:
determining an epipolar line in the second image based at least in part on the edge point; and
determining a corresponding point in the second image that is positioned on the epipolar line and has a second phase value that is substantially the same as the first phase value.

5. The method of claim 4, further comprising illuminating the object with a substantially uniform light prior to acquiring the first image and the second image.

6. The method of claim 4, further comprising:
determining a second edge point in the second image, the second edge point having a third phase value;
determining a second epipolar line in the first image based at least in part on the second edge point; and
determining a second corresponding point in the first image that is positioned on the second epipolar line and has a fourth phase value that is substantially the same as the third phase value.

7. The method of claim 1, wherein the at least two image devices includes the first camera and a projector.

8. A system for generating a point cloud of a scanned object, the system comprising:
a coordinate measurement device having at least two image devices, the at least two image devices including a first camera, the coordinate measurement device being operable to determine a distance to each of a plurality of points on the object using a phase based at least in part on a phase shift of a light emitted from a coordinate measurement device; and
one or more processors that are responsive to executable computer instructions when performed on the one or more processors for performing a method comprising:
generating a point cloud based at least in part on the distances to the plurality of points;
identifying an edge point from a two-dimensional image acquired by the first camera;
determining a corresponding point in the other image device based at least in part on a first phase value of the edge point and a epipolar relationship between the first camera and the image device;
determining the three-dimensional coordinates of the edge point and corresponding point based on triangulation; and
adding the edge point to the point cloud.

9. The system of claim 8, wherein the at least two image devices includes the first camera, a second camera and a projector arranged in a predetermined geometrical relationship.

10. The system of claim 9, wherein the method further comprises acquiring a second two-dimensional image with the second camera.

11. The system of claim 10, wherein the determining a corresponding point includes:
determining an epipolar line in the second image based at least in part on the edge point; and
determining a corresponding point in the second image that is positioned on the epipolar line and has a second phase value that is substantially the same as the first phase value.

12. The system of claim 11, further comprising a light source arranged to illuminate the object with a substantially uniform light, wherein the method further comprises illuminating the object prior to acquiring the first image and the second image.

13. The system of claim 12, wherein the method further comprises acquiring the the first image and second image before the determining a distance to each of a plurality of points.

14. The system of claim 11, wherein the method further comprises:
determining a second edge point in the second image, the second edge point having a third phase value;
determining a second epipolar line in the first image based at least in part on the second edge point; and
determining a second corresponding point in the first image that is positioned on the second epipolar line and has a fourth phase value that is substantially the same as the third phase value.

15. The system of claim 8, wherein the at least two image devices includes the first camera and a projector.
